(19) United States
(12) Patent Application Publication
(10) Pub. No.: US 2022/0019060 A1
(43) Pub. Date: Jan. 20, 2022

(54) Optical Imaging Lens Assembly

(71) Applicant: ZHEJIANG SUNNY OPTICS CO., LTD., Ningbo (CN)

(72) Inventors: Shuang ZHANG, Ningbo (CN); Xiaobin ZHANG, Ningbo (CN); Jianke WENREN, Ningbo (CN); Fujian DAI, Ningbo (CN); Liefeng ZHAO, Ningbo (CN)

(21) Appl. No.: 17/353,835

(22) Filed: Jun. 22, 2021

(30) Foreign Application Priority Data
Jul. 17, 2020 (CN) 202010691559.9

(51) Int. Cl. G02B 13/00; G02B 9/60

(52) U.S. Cl. CPC G02B 13/0045; G02B 9/60

(57) ABSTRACT

The disclosure provides an optical imaging lens assembly, which sequentially includes, from an object side to an image side along an optical axis: a first lens with a positive refractive power; a second lens with a negative refractive power; a third lens, an object-side surface thereof is a convex surface; a fourth lens with a positive refractive power; and a fifth lens with a negative refractive power, an object-side surface thereof is a convex surface, wherein an on-axis distance VP from an intersection point of a straight line where a marginal ray of the optical imaging lens assembly and the optical axis to an object-side surface of the first lens satisfies 0 mm<VP<0.8 mm.

### CROSS-REFERENCE TO RELATED APPLICATION(S)

The disclosure claims priority to and the benefit of Chinese Patent Application No. 202010691559.9, filed in the China National Intellectual Property Administration (CNIPA) on 17 Jul. 2020, which is incorporated herein by reference in its entirety.

### TECHNICAL FIELD

The disclosure relates to the field of optical elements, and more particularly to an optical imaging lens assembly.

### BACKGROUND

With the constant development of social software, shooting photos, short videos and the like with mobile phones and sharing them in social software has become a common and even indispensable part in lives of consumers. Meanwhile, people expect to shoot high-quality images or videos.

Consumers also have certain expectations to appearances of electronic products such as mobile phones based on requirements on usable functions. For example, when a mobile phone is provided with a front camera module on a screen side, the front camera module may be arranged outside a screen such that the front camera module may receive imaging light. However, in such a manner, a panel of the mobile phone may be enlarged, and a ratio of the screen to the panel may be reduced. Consumers prefer mobile phones with relatively high screen-to-body ratios. At present, in various screens of mobile phones, holed screen, waterdrop screen and the like gradually become mainstreams on the market. In these manners, screens are windowed such that imaging light gets incident into camera modules behind the screens.

For meeting a miniaturization requirement and an imaging requirement, an optical imaging lens assembly that is ultra-thin and small in structural size and has a good imaging effect is required, and a depth of field of the optical imaging lens assembly is small or a required window diameter is small.

### SUMMARY

The disclosure provides an optical imaging lens assembly, which sequentially includes, from an object side to an image side along an optical axis: a first lens with a positive refractive power; a second lens with a negative refractive power; a third lens with a refractive power, an object-side surface thereof is a convex surface; a fourth lens with a positive refractive power; and a fifth lens with a negative refractive power, an object-side surface thereof is a convex surface, wherein an on-axis distance VP from an intersection point of a straight line where a marginal ray of the optical imaging lens assembly and the optical axis to an object-side surface of the first lens may satisfy: 0 mm<VP<0.8 mm.

In an implementation mode, the object-side surface of the first lens to an image-side surface of the fifth lens includes at least one aspheric mirror surface.

In an implementation mode, TTL is a spacing distance from the object-side surface of the first lens to an imaging surface of the optical imaging lens assembly on the optical axis and ImgH is a half of a diagonal length of an effective pixel region on the imaging surface of the optical imaging lens assembly may satisfy: 4.5 mm<TTL×TTL/ImgH<5.5 mm.

In an implementation mode, a maximum field of view (FOV) of the optical imaging lens assembly may satisfies: 70°<FOV<90°.

In an implementation mode, an effective focal length f1 of the first lens, an effective focal length f4 of the fourth lens and a total effective focal length f of the optical imaging lens assembly may satisfy: 1.6<(f1+f4)/f<2.1.

In an implementation mode, an effective focal length f2 of the second lens and an effective focal length f5 of the fifth lens may satisfy: 2.2<f2/f5<3.8.

In an implementation mode, a curvature radius R5 of an object-side surface of the third lens and a curvature radius R9 of an image-side surface of the fifth lens may satisfy: 1.8<R5/R9<3.1.

In an implementation mode, the total effective focal length f of the optical imaging lens assembly and a curvature radius R10 of the image-side surface of the fifth lens may satisfy: 4.1 f/R10<4.6.

In an implementation mode, TTL is a spacing distance from the object-side surface of the first lens to an imaging surface of the optical imaging lens assembly on the optical axis, TTL satisfies: 3.0 mm<TTL<4.0 mm.

In an implementation mode, a center thickness CT4 of the fourth lens on the optical axis, a spacing distance T45 of the fourth lens and the fifth lens on the optical axis and a center thickness CT5 of the fifth lens on the optical axis may satisfy: 0.7<CT4/(T45+CT5)<1.0.

In an implementation mode, ImgH is a half of the diagonal length of the effective pixel region on an imaging surface of the optical imaging lens assembly, an effective radius DT11 of the object-side surface of the first lens, an effective radius DT12 of an image-side surface of the first lens and ImgH may satisfy: 0.4<(DT11+DT12)/ImgH<0.6.

In an implementation mode, SL is a spacing distance from the diaphragm to an imaging surface of the optical imaging lens assembly on the optical axis, and TTL is a spacing distance from the object-side surface of the first lens to the imaging surface of the optical imaging lens assembly on the optical axis, TTL and SL may satisfy: SL/TTL>0.9.

In an implementation mode, SAG42 is an on-axis distance from an intersection point of an image-side surface of the fourth lens and the optical axis to an effective radius vertex of the image-side surface of the fourth lens, and SAG41 is an on-axis distance from an intersection point of an object-side surface of the fourth lens and the optical axis to an effective radius vertex of the object-side surface of the fourth lens, SAG42 and SAG41 may satisfy: 1.8<SAG42/SAG41<2.6.

In an implementation mode, a combined focal length f123 of the first lens, the second lens and the third lens, a center thickness CT1 of the first lens on the optical axis, a center thickness CT2 of the second lens on the optical axis and a center thickness CT3 of the third lens on the optical axis may satisfy: 4.1<f123/(CT1+CT2+CT3)<4.9.

In an implementation mode, an edge thickness ET4 of the fourth lens, an edge thickness ET5 of the fifth lens, a center thickness CT4 of the fourth lens on the optical axis and a center thickness CT5 of the fifth lens on the optical axis may satisfy: 0.7<(ET4+ET5)/(CT4+CT5)<1.0.

In an implementation mode, the on-axis distance VP from the intersection point of the straight line where the marginal ray of the optical imaging lens assembly and the optical axis to the object-side surface of the first lens and a maximum field of view (FOV) of the optical imaging lens assembly may satisfy: 1.0 mm<2×VP×tan(FOV/2)<1.5 mm.

Another aspect of the disclosure provides an optical imaging lens assembly, which sequentially includes, from an object side to an image side along an optical axis: a first lens with a positive refractive power; a second lens with a negative refractive power; a third lens with a refractive power, an object-side surface thereof is a convex surface; a fourth lens with a positive refractive power; and a fifth lens with a negative refractive power, an object-side surface thereof is a convex surface, wherein an on-axis distance VP from an intersection point of a straight line where a marginal ray of the optical imaging lens assembly and the optical axis to an object-side surface of the first lens and a maximum field of view (FOV) of the optical imaging lens assembly may satisfy: 1.0 mm<2×VP×tan(FOV/2)<1.5 mm.

In an implementation mode, TTL is a spacing distance from the object-side surface of the first lens to an imaging surface of the optical imaging lens assembly on the optical axis, and ImgH is a half of a diagonal length of an effective pixel region on the imaging surface of the optical imaging lens assembly, TTL and ImgH may satisfy: 4.5 mm<TTL×TTL/ImgH<5.5 mm.

In an implementation mode, the maximum FOV of the optical imaging lens assembly may satisfy: 70°<FOV<90°.

In an implementation mode, an effective focal length f1 of the first lens, an effective focal length f4 of the fourth lens and a total effective focal length f of the optical imaging lens assembly may satisfy: 1.6<(f1+f4)/f<2.1.

In an implementation mode, an effective focal length f2 of the second lens and an effective focal length f5 of the fifth lens may satisfy: 2.2<f2/f5<3.8.

In an implementation mode, a curvature radius R5 of an object-side surface of the third lens and a curvature radius R9 of an image-side surface of the fifth lens may satisfy: 1.8<R5/R9<3.1.

In an implementation mode, the total effective focal length f of the optical imaging lens assembly and a curvature radius R10 of an image-side surface of the fifth lens may satisfy: 4.1 f/R10<4.6.

In an implementation mode, TTL is a spacing distance from the object-side surface of the first lens to the imaging surface of the optical imaging lens assembly on the optical axis may satisfy: 3.0 mm<TTL<4.0 mm.

In an implementation mode, a center thickness CT4 of the fourth lens on the optical axis, a spacing distance T45 of the fourth lens and the fifth lens on the optical axis and a center thickness CT5 of the fifth lens on the optical axis may satisfy: 0.7<CT4/(T45+CT5)<1.0.

In an implementation mode, ImgH is a half of the diagonal length of the effective pixel region on an imaging surface of the optical imaging lens assembly, an effective radius DT11 of the object-side surface of the first lens, an effective radius DT12 of an image-side surface of the first lens and ImgH may satisfy: 0.4<(DT11+DT12)/ImgH<0.6.

In an implementation mode, SL is a spacing distance from the diaphragm to an imaging surface of the optical imaging lens assembly on the optical axis, and TTL is a spacing distance from the object-side surface of the first lens to the imaging surface of the optical imaging lens assembly on the optical axis, TTL and SL may satisfy: SL/TTL>0.9.

In an implementation mode, SAG42 is an on-axis distance from an intersection point of an image-side surface of the fourth lens and the optical axis to an effective radius vertex of the image-side surface of the fourth lens and SAG41 is an on-axis distance from an intersection point of an object-side surface of the fourth lens and the optical axis to an effective radius vertex of the object-side surface of the fourth lens, SAG42 and SAG41 may satisfy: 1.8<SAG42/SAG41<2.6.

In an implementation mode, a combined focal length f123 of the first lens, the second lens and the third lens, a center thickness CT1 of the first lens on the optical axis, a center thickness CT2 of the second lens on the optical axis and a center thickness CT3 of the third lens on the optical axis may satisfy: 4.1<f123/(CT1+CT2+CT3)<4.9.

In an implementation mode, an edge thickness ET4 of the fourth lens, an edge thickness ET5 of the fifth lens, a center thickness CT4 of the fourth lens on the optical axis and a center thickness CT5 of the fifth lens on the optical axis may satisfy: 0.7<(ET4+ET5)/(CT4+CT5)<1.0.

In an implementation mode, the on-axis distance VP from the intersection point of the straight line where the marginal ray of the optical imaging lens assembly and the optical axis to the object-side surface of the first lens may satisfy: 0 mm<VP<0.8 mm.

According to the disclosure, the five lenses are adopted, and the refractive power and surface types of each lens, the center thickness of each lens, on-axis distances between the lenses and the like are reasonably configured to achieve at least one beneficial effect of ultra-thin design, small structural size, good imaging effect, small depth of field, small required window diameter and the like of the optical imaging lens assembly.

### BRIEF DESCRIPTION OF THE DRAWINGS

Detailed descriptions are made to unrestrictive implementation modes below in combination with the drawings to make the other characteristics, purposes and advantages of the disclosure more apparent. In the drawings:

FIG. 1 shows a schematic beam path diagram of an optical imaging lens assembly according to an embodiment of the disclosure;

FIG. 2 shows a structure diagram of an optical imaging lens assembly according to Embodiment 1 of the disclosure;

FIGS. 3A-3D show a longitudinal aberration curve, an astigmatism curve, a distortion curve and a lateral color curve of an optical imaging lens assembly according to Embodiment 1 respectively;

FIG. 4 shows a structure diagram of an optical imaging lens assembly according to Embodiment 2 of the disclosure;

FIGS. 5A-5D show a longitudinal aberration curve, an astigmatism curve, a distortion curve and a lateral color curve of an optical imaging lens assembly according to Embodiment 2 respectively;

FIG. 6 shows a structure diagram of an optical imaging lens assembly according to Embodiment 3 of the disclosure;

FIGS. 7A-7D show a longitudinal aberration curve, an astigmatism curve, a distortion curve and a lateral color curve of an optical imaging lens assembly according to Embodiment 3 respectively;

FIG. 8 shows a structure diagram of an optical imaging lens assembly according to Embodiment 4 of the disclosure;

FIGS. 9A-9D show a longitudinal aberration curve, an astigmatism curve, a distortion curve and a lateral color curve of an optical imaging lens assembly according to Embodiment 4 respectively;

FIG. 10 shows a structure diagram of an optical imaging lens assembly according to Embodiment 5 of the disclosure;

FIGS. 11A-11D show a longitudinal aberration curve, an astigmatism curve, a distortion curve and a lateral color curve of an optical imaging lens assembly according to Embodiment 5 respectively;

FIG. 12 shows a structure diagram of an optical imaging lens assembly according to Embodiment 6 of the disclosure;

FIGS. 13A-13D show a longitudinal aberration curve, an astigmatism curve, a distortion curve and a lateral color curve of an optical imaging lens assembly according to Embodiment 6 respectively.

### DETAILED DESCRIPTION OF THE EMBODIMENTS

For understanding the disclosure better, more detailed descriptions will be made to each aspect of the disclosure with reference to the drawings. It is to be understood that these detailed descriptions are only descriptions about the exemplary implementation modes of the disclosure and not intended to limit the scope of the disclosure in any manner. In the whole specification, the same reference sign numbers represent the same components. Expression “and/or” includes any or all combinations of one or more in associated items that are listed.

It should be noted that, in this description, the expressions of first, second, third, etc. are only used to distinguish one feature from another feature, and do not represent any limitation to the feature. Thus, a first lens discussed below could also be referred to as a second lens or a third lens without departing from the teachings of the disclosure.

In the drawings, the thickness, size and shape of the lens have been slightly exaggerated for ease illustration. In particular, a spherical shape or aspheric shape shown in the drawings is shown by some embodiments. That is, the spherical shape or the aspheric shape is not limited to the spherical shape or aspheric shape shown in the drawings. The drawings are by way of example only and not strictly to scale.

Herein, a paraxial region refers to a region nearby an optical axis. If a lens surface is a convex surface and a position of the convex surface is not defined, it indicates that the lens surface is a convex surface at least in the paraxial region; and if a lens surface is a concave surface and a position of the concave surface is not defined, it indicates that the lens surface is a concave surface at least in the paraxial region. A surface, closest to a shot object, of each lens is called an object-side surface of the lens, and a surface, closest to an imaging surface, of each lens is called an image-side surface of the lens.

It should also be understood that terms “include”, “including”, “have”, “contain” and/or “containing”, used in the specification, represent existence of a stated characteristic, component and/or part but do not exclude existence or addition of one or more other characteristics, components and parts and/or combinations thereof. In addition, expressions like “at least one in . . . ” may appear after a list of listed characteristics not to modify an individual component in the list but to modify the listed characteristics. Moreover, when the implementation modes of the disclosure are described, “may” is used to represent “one or more implementation modes of the disclosure”. Furthermore, term “exemplary” refers to an example or exemplary description.

Unless otherwise defined, all terms (including technical terms and scientific terms) used in the disclosure have the same meanings usually understood by those of ordinary skill in the art of the disclosure. It is also to be understood that the terms (for example, terms defined in a common dictionary) should be explained to have meanings consistent with the meanings in the context of a related art and may not be explained with ideal or excessively formal meanings, unless clearly defined like this in the disclosure.

It is to be noted that the embodiments in the disclosure and characteristics in the embodiments may be combined without conflicts. The disclosure will be described below with reference to the drawings and in combination with the embodiments in detail.

The features, principles and other aspects of the disclosure will be described below in detail.

The optical imaging lens assembly according to the exemplary embodiment of the disclosure may include, for example, five lenses with a refractive power, i.e., a first lens, a second lens, a third lens, a fourth lens and a fifth lens. The five lenses are sequentially arranged from an object side to an image side along an optical axis. In the first lens to the fifth lens, there may be an air space between any two adjacent lenses.

In an exemplary embodiment, the first lens may have a positive refractive power; the second lens may have a negative refractive power; the third lens may have a positive refractive power or a negative refractive power, and an object-side surface thereof may be a convex surface; the fourth lens may have a positive refractive power; and the fifth lens may have a negative refractive power, and an object-side surface thereof may be a convex surface. The first lens with the positive refractive power acts to converge light. The second lens with the negative refractive power may diverge light, and may be combined with the first lens to ensure smooth light transmission. Light transmitted through the second lens passes through the third lens. Through the third lens of which the object-side surface is a convex surface, a spherical aberration and chromatic aberration of the optical imaging lens assembly may be comprehensively corrected. The fourth lens with the positive refractive power and the fifth lens which has the negative refractive power and of which the object-side surface is a convex surface are favorable for optimizing a field curvature and astigmatism of the optical imaging lens assembly.

In an exemplary embodiment, the optical imaging lens assembly may further include at least one diaphragm. The diaphragm may be arranged at a proper position as required, for example, arranged between the object side and the first lens. Optionally, the optical imaging lens assembly may further include an optical filter configured to correct the chromatic aberration and/or protective glass configured to protect a photosensitive element on an imaging surface.

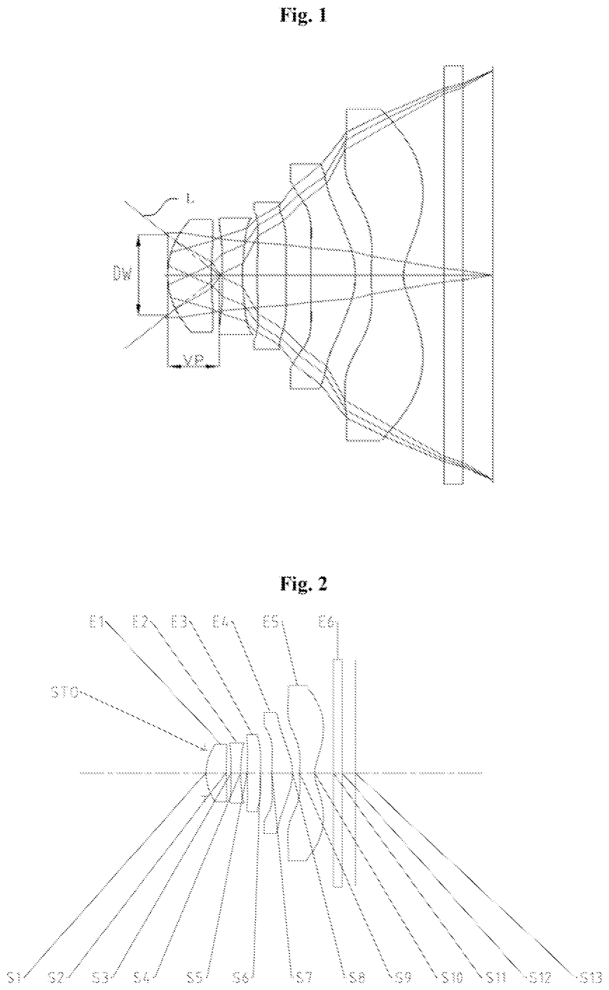

In an exemplary embodiment, referring to FIG. 1, the optical imaging lens assembly of the disclosure may satisfy a conditional expression 0 mm<VP<0.8 mm, wherein VP is an on-axis distance from an intersection point of a straight line where a marginal ray of the optical imaging lens assembly and the optical axis to an object-side surface of the first lens. 0 mm<VP<0.8 mm is satisfied, so that the optical imaging lens assembly has a relatively small depth of field, a window diameter on a screen of an electronic device adopting the optical imaging lens assembly, such as a mobile phone, is relatively small, and a requirement on a small holing size of a holed screen or a waterdrop screen may be satisfied. More specifically, VP may further satisfy: 0.55 mm<VP<0.75 mm.

In an exemplary embodiment, the optical imaging lens assembly of the disclosure may satisfy: a conditional expression 4.5 mm<TTL×TTL/ImgH<5.5 mm, wherein TTL is a spacing distance from the object-side surface of the first lens to the imaging surface of the optical imaging lens assembly on the optical axis, and ImgH is a half of a diagonal length of an effective pixel region on the imaging surface of the optical imaging lens assembly. The optical imaging lens assembly satisfing 4.5 mm<TTL×TTL/ImgH<5.5 mm has the characteristics of ultra-thin design and small size, and the optical imaging lens assembly may be endowed with the structural characteristic of small size. More specifically, TTL and ImgH satisfy: 4.60 mm<TTL×TTL/ImgH<5.48 mm.

In an exemplary embodiment, the optical imaging lens assembly of the disclosure may satisfy a conditional expression 70°<FOV<90°, wherein FOV is a maximum field of view of the optical imaging lens assembly. The maximum field of view in this range may satisfy an imaging requirement of the optical imaging lens assembly, and is also helpful to reduce a depth VP of the optical imaging lens assembly, thereby achieving an effect of reducing the window diameter of the optical imaging lens assembly and also reducing a window size of the device adopting the optical imaging lens assembly. More specifically, FOV may further satisfy: 77°<FOV<88°.

In an exemplary embodiment, the optical imaging lens assembly of the disclosure may satisfy a conditional expression 1.6<(f1+f4)/f<2.1, wherein f1 is an effective focal length of the first lens, f4 is an effective focal length of the fourth lens, and f is a total effective focal length of the optical imaging lens assembly. 1.6<(f1+f4)/f<2.1 is satisfied, so that a relationship between the focal lengths of the first lens and the fourth lens and the total effective focal length may be configured reasonably, smooth light transmission is further facilitated at the same time of optimizing a shape of the first lens and a shape of the fourth lens, and the sensitivity of the first lens and the sensitivity of the fourth lens are also reduced. More specifically, f1, f4 and f may satisfy: 1.73<(f1+f4)/f<1.95.

In an exemplary embodiment, the optical imaging lens assembly of the disclosure may satisfy a conditional expression 2.2<f2/f5<3.8, wherein f2 is an effective focal length of the second lens, and f5 is an effective focal length of the fifth lens. Controlling a ratio of the effective focal length of the second lens to the effective focal length of the fifth lens in this range is favorable for optimizing the spherical aberration of the optical imaging lens assembly, may simultaneously reduce the sensitivity of the second lens, and may also optimize a lens shape of the fifth lens.

In an exemplary embodiment, the optical imaging lens assembly of the disclosure may satisfy a conditional expression 1.8<R5/R9<3.1, wherein R5 is a curvature radius of the object-side surface of the third lens, and R9 is a curvature radius of the image-side surface of the fifth lens. Satisfing 1.8<R5/R9<3.1 is helpful to optimize a lens shape of the third lens and the lens shape of the fifth lens and also favorable for configuring the refractive power of the third lens and the fifth lens reasonably, and may control the field curvature of the optical imaging lens assembly in a certain range to further reduce the aberration of the optical imaging lens assembly.

In an exemplary embodiment, the optical imaging lens assembly of the disclosure may satisfy a conditional expression 4.1<f/R10<4.6, wherein f is the total effective focal length of the optical imaging lens assembly, and R10 is a curvature radius of an image-side surface of the fifth lens. Satisfing 4.1<f/R10<4.6 is helpful to optimize a structure of the fifth lens. Improving the structure of the fifth lens is favorable for optimizing a field curvature of an outer field of view of the optical imaging lens assembly and improve a ghost image phenomenon formed by reflection in the fifth lens.

In an exemplary embodiment, the optical imaging lens assembly of the disclosure may satisfy a conditional expression 3.0 mm<TTL<4.0 mm, wherein TTL is the spacing distance from the object-side surface of the first lens to the imaging surface of the optical imaging lens assembly on the optical axis. The Total Track Length may be restricted in a proper range to define an overall size of the whole optical imaging lens assembly to further ensure that the optical imaging lens assembly is in a machinable process range and also ensure a relatively small structural shape. More specifically, TTL may satisfy: 3.50 mm<TTL<3.60 mm.

In an exemplary embodiment, the optical imaging lens assembly of the disclosure may satisfy a conditional expression 0.7<CT4/(T45+CT5)<1.0, wherein CT4 is a center thickness of the fourth lens on the optical axis, T45 is a spacing distance of the fourth lens and the fifth lens on the optical axis, and CT5 is a center thickness of the fifth lens on the optical axis. 0.7<CT4/(T45+CT5)<1.0 is satisfied, so that a proportional relationship between on-axis sizes of the fourth lens, the fifth lens and an air space between the fourth lens and the fifth lens may be controlled to further optimize the manufacturability of the optical imaging lens assembly, regulation of the field curvature of the optical imaging lens assembly in an assembling process is also facilitated, and meanwhile, optimization of a ghost image phenomenon formed by four reflections at the fourth lens and the fifth lens may be facilitated. More specifically, CT4, T45 and CT5 may further satisfy: 0.81<CT4/(T45+CT5)<0.95.

In an exemplary embodiment, the optical imaging lens assembly of the disclosure may satisfy a conditional expression 0.4<(DT11+DT12)/ImgH<0.6, wherein DT11 is an effective radius of the object-side surface of the first lens, DT12 is an effective radius of an image-side surface of the first lens, and ImgH is a half of the diagonal length of the effective pixel region on the imaging surface of the optical imaging lens assembly. Satisfying 0.4<(DT11+DT12)/ImgH<0.6 is favorable for reducing a size of a head of the optical imaging lens assembly. More specifically, DT11, DT12 and ImgH satisfy 0.47<(DT11+DT12)/ImgH<0.60.

In an exemplary embodiment, the optical imaging lens assembly further includes a diaphragm. The optical imaging lens assembly of the disclosure may satisfy a conditional expression SL/TTL>0.9, wherein SL is a spacing distance from the diaphragm to the imaging surface of the optical imaging lens assembly on the optical axis, and TTL is the spacing distance from the object-side surface of the first lens to the imaging surface on the optical axis. Restricting a ratio of the on-axis distance from the diaphragm to the imaging surface of the optical imaging lens assembly to the Total Track Length in this range is favorable for reducing the depth of field of the optical imaging lens assembly, thereby achieving the characteristic of small window diameter of the optical imaging lens assembly. More specifically, SL and TTL may further satisfy: 0.99≤SL/TTL≤1.02.

In an exemplary embodiment, the optical imaging lens assembly of the disclosure may satisfy a conditional expression 1.8<SAG42/SAG41<2.6, wherein SAG42 is an on-axis distance from an intersection point of an image-side surface of the fourth lens and the optical axis to an effective radius vertex of the image-side surface of the fourth lens, and SAG41 is an on-axis distance from an intersection point of an object-side surface of the fourth lens and the optical axis to an effective radius vertex of the object-side surface of the fourth lens. Satisfying 1.8<SAG42/SAG41<2.6 is favorable for optimizing the shape and manufacturability of the fourth lens and may also optimize an optical distortion and field curvature of the optical imaging lens assembly to further reduce the aberration of the optical imaging lens assembly. More specifically, SAG42 and SAG41 may further satisfy: 1.96<SAG42/SAG41<2.60.

In an exemplary embodiment, the optical imaging lens assembly of the disclosure may satisfy a conditional expression 4.1<f123/(CT1+CT2+CT3)<4.9, wherein f123 is a combined focal length of the first lens, the second lens and the third lens, CT1 is a center thickness of the first lens on the optical axis, CT2 is a center thickness of the second lens on the optical axis, and CT3 is a center thickness of the third lens on the optical axis. Controlling a relationship between the combined focal length of the first three lenses and a sum of the center thicknesses of the first three lenses may eliminate the chromatic aberration, spherical aberration and coma of the optical imaging lens assembly to further achieve a purpose of reducing the aberration of the optical imaging lens assembly, and meanwhile, is favorable for structurally arranging the optical imaging lens assembly to further optimize the process performance of the optical imaging lens assembly and reduce the sensitivity of the lens. More specifically, f123, CT1, CT2 and CT3 may further satisfy: 4.13<f123/(CT1+CT2+CT3)<4.86.

In an exemplary embodiment, the optical imaging lens assembly of the disclosure may satisfy a conditional expression 0.7<(ET4+ET5)/(CT4+CT5)<1.0, wherein ET4 is an edge thickness of the fourth lens, ET5 is an edge thickness of the fifth lens, CT4 is the center thickness of the fourth lens on the optical axis, and CT5 is the center thickness of the fifth lens on the optical axis. 0.7<(ET4+ET5)/(CT4+CT5)<1.0 is satisfied, so that the strength of the fourth lens and the strength of the fifth lens may be enhanced, the process performance of the two lenses may be improved, and a deformation degree after the two lenses are assembled to the optical imaging lens assembly may be reduced to achieve a purpose of optimizing the field curvature. More specifically, ET4, ET5, CT4 and CT5 may further satisfy: 0.80<(ET4+ET5)/(CT4+CT5)<0.90.

In an exemplary embodiment, the optical imaging lens assembly of the disclosure may satisfy a conditional expression 1.0 mm<2×VP×tan(FOV/2)<1.5 mm, wherein VP is the on-axis distance from the intersection point of the straight line where the marginal ray of the optical imaging lens assembly and the optical axis to the object-side surface of the first lens, and FOV is the maximum field of view of the optical imaging lens assembly. 1.0 mm<2×VP×tan(FOV/2)<1.5 mm is satisfied, so that a magnitude of the window diameter DW required by the optical imaging lens assembly may be limited, and furthermore, for an imaging electronic device that the optical imaging lens assembly is required to be assembled in, a window diameter on a screen thereof may be reduced. More specifically, VP and FOV may satisfy: 1.1 mm<2×VP×tan(FOV/2)<1.2 mm.

The optical imaging lens assembly according to the implementation mode of the disclosure may adopt multiple lenses, for example, the abovementioned five lenses. The refractive power and surface types of each lens, the center thickness of each lens, on-axis distances between the lenses and the like are reasonably configured to effectively reduce the size of the optical imaging lens assembly, reduce the thickness of the optical imaging lens assembly, reduce the window diameter, reduce the depth of field, improve the machinability of the optical imaging lens assembly and ensure that the optical imaging lens assembly is more favorable for production and machining and applicable to a portable electronic product. In addition, the optical imaging lens assembly of the disclosure also has high optical performance such as a good imaging effect.

In the implementation mode of the disclosure, at least one of mirror surfaces of each lens is an aspheric mirror surface, namely at least one of the object-side surface of the first lens to an image-side surface of the fifth lens is an aspheric mirror surface. An aspheric lens has a characteristic that a curvature keeps changing from a center of the lens to a periphery of the lens. Unlike a spherical lens with a constant curvature from a center of the lens to a periphery of the lens, the aspheric lens has a better curvature radius characteristic and the advantages of improving distortion aberrations and improving astigmatic aberrations. With adoption of the aspheric lens, astigmatic aberrations during imaging may be eliminated as much as possible, thereby improving the imaging quality. Optionally, at least one of the object-side surface and image-side surface of each lens in the first lens, the second lens, the third lens, the fourth lens and the fifth lens is an aspheric mirror surface. Optionally, both the object-side surface and image-side surface of each lens in the first lens, the second lens, the third lens, the fourth lens and the fifth lens are aspheric mirror surfaces.

However, those skilled in the art should know that the number of the lenses forming the optical imaging lens assembly may be changed without departing from the technical solutions claimed in the disclosure to achieve each result and advantage described in the specification. For example, although descriptions are made in the implementation with five lenses as an example, the optical imaging lens assembly is not limited to five lenses. If necessary, the optical imaging lens assembly may further include another number of lenses.

Specific embodiments of the optical imaging lens assembly applied to the abovementioned implementation mode will further be described below with reference to the drawings.

### Embodiment 1

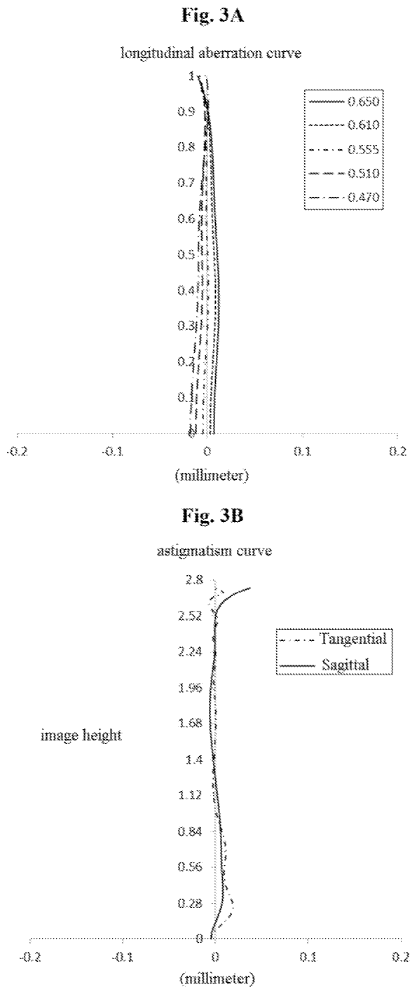

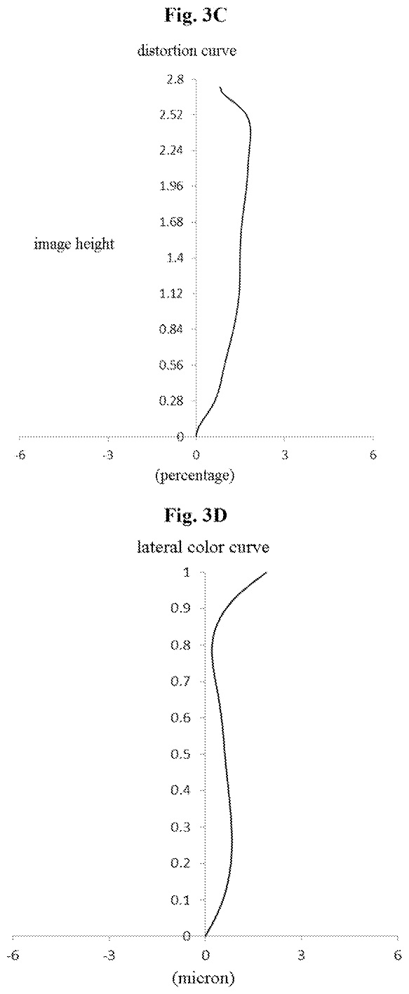

An optical imaging lens assembly according to Embodiment 1 of the disclosure will be described below with reference to FIGS. 2-3D. FIG. 2 shows a structure diagram of an optical imaging lens assembly according to Embodiment 1 of the disclosure.

As shown in FIG. 2, the optical imaging lens assembly sequentially includes, from an object side to an image side along an optical axis, a diaphragm STO, a first lens E1, a second lens E2, a third lens E3, a fourth lens E4, a fifth lens E5 and an optical filter E6.

The first lens E1 has a positive refractive power, an object-side surface S1 thereof is a convex surface, while an image-side surface S2 is a concave surface. The second lens E2 has a negative refractive power, an object-side surface S3 thereof is a convex surface, while an image-side surface S4 is a concave surface. The third lens E3 has a positive refractive power, an object-side surface S5 thereof is a convex surface, while an image-side surface S6 is a concave surface. The fourth lens E4 has a positive refractive power, an object-side surface S7 thereof is a convex surface, while an image-side surface S8 is a convex surface. The fifth lens E5 has a negative refractive power, an object-side surface S9 thereof is a convex surface, while an image-side surface S10 is a concave surface. The optical filter E6 has an object-side surface S11 and an image-side surface S12. The optical imaging lens assembly has an imaging surface S13. Light from an object sequentially penetrates through each of the surfaces S1 to S12 and is finally imaged on the imaging surface S13.

Table 1 shows a table of basic parameters for the optical imaging lens assembly of Embodiment 1, wherein the units of the curvature radius, the thickness/distance, and the focal length are all millimeter (mm).

TABLE 1

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | 350.0000 | | | | |
| STO | Spherical | Infinite | 0.0300 | | | | |
| S1 | Aspheric | 1.2420 | 0.4773 | 1.55 | 56.1 | 3.21 | −1.8564 |
| S2 | Aspheric | 3.6775 | 0.1200 | | | | 12.2985 |
| S3 | Aspheric | 8.7738 | 0.2250 | 1.68 | 19.2 | −7.79 | −99.0000 |
| S4 | Aspheric | 3.2605 | 0.1573 | | | | −22.4569 |
| S5 | Aspheric | 4.5339 | 0.3200 | 1.55 | 56.1 | 55.77 | 16.5623 |
| S6 | Aspheric | 5.1944 | 0.2699 | | | | −8.6647 |
| S7 | Aspheric | 7.6397 | 0.4909 | 1.54 | 55.7 | 2.23 | −99.0000 |
| S8 | Aspheric | −1.3902 | 0.1688 | | | | −0.6967 |
| S9 | Aspheric | 2.0168 | 0.3550 | 1.54 | 55.7 | −2.11 | −67.1109 |
| S10 | Aspheric | 0.6800 | 0.4458 | | | | −4.9440 |
| S11 | Spherical | Infinite | 0.2100 | 1.52 | 64.2 | | |
| S12 | Spherical | Infinite | 0.3200 | | | | |
| S13 | Spherical | Infinite | | | | | |

In Embodiment 1, a value of a total effective focal length f of the optical imaging lens assembly is 2.82 mm, TTL is an on-axis distance from the object-side surface S1 of the first lens E1 to the imaging surface S13, a value of TTL is 3.56 mm, and a value of ImgH (ImgH is a half of a diagonal length of an effective pixel region on the imaging surface S13) is 2.74 mm.

In Embodiment 1, both the object-side surface and image-side surface of any lens in the first lens E1 to the fifth lens E5 are aspheric surfaces, and a surface type x of each aspheric lens may be defined through, but not limited to, the following aspheric surface formula:

$$x = \frac{{ch}^{2}}{1 + \sqrt{1 - ( k + 1 ) {c}^{2} {h}^{2}}} + \sum A i {h}^{i} , \qquad ( 1 )$$

wherein x is a distance vector height from a vertex of the aspheric surface when the aspheric surface is at a height of h along the optical axis direction; c is a paraxial curvature of the aspheric surface, c=1/R (namely, the paraxial curvature c is a reciprocal of the curvature radius R in Table 1); k is a cone coefficient; and Ai is a correction coefficient of the i-th order of the aspheric surface. Table 2 below gives higher order term coefficients A4, A6, A8, A10, A12, A14, A16, A18 and A20 that may be used for each of the aspheric mirror surfaces S1-S10 in Embodiment 1.

TABLE 2

| Surface | | | | | |
|---|---|---|---|---|---|
| number | A4 | A6 | A8 | A10 | A12 |
| S1 | 1.2806E−01 | −1.7620E−01 | 2.7368E+00 | −2.5099E+01 | 1.3603E+02 |
| S2 | −2.0300E−01 | 7.7186E−02 | −4.0905E+00 | 2.9441E+01 | −1.3567E+02 |
| S3 | −3.1219E−01 | 4.7937E−01 | −7.5752E+00 | 5.4222E+01 | −2.5275E+02 |
| S4 | −1.5793E−01 | 8.2151E−01 | −3.4872E+00 | 6.4712E+00 | 1.6420E+01 |
| S5 | −5.3259E−01 | 2.8834E+00 | −1.7447E+01 | 7.9617E+01 | −2.5227E+02 |
| S6 | −6.2921E−01 | 2.4254E+00 | −1.0201E+01 | 3.0898E+01 | −6.5285E+01 |
| S7 | −2.1047E−01 | 4.7476E−01 | 1.2273E+00 | −1.4748E+01 | 5.6585E+01 |
| S8 | −2.7199E−01 | 2.3470E+00 | −7.3281E+00 | 1.6668E+01 | −2.9348E+01 |
| S9 | −8.9381E−01 | 1.9754E+00 | −3.1741E+00 | 3.2677E+00 | −2.0296E+00 |
| S10 | −4.1382E−01 | 7.1574E−01 | −9.8807E−01 | 9.8584E−01 | −7.0538E−01 |

| Surface | | | | |
|---|---|---|---|---|
| number | A14 | A16 | A18 | A20 |
| S1 | −4.4906E+02 | 8.8625E+02 | −9.5830E+02 | 4.3459E+02 |
| S2 | 3.9529E+02 | −6.5485E+02 | 5.5570E+02 | −1.8622E+02 |
| S3 | 7.7154E+02 | −1.3712E+03 | 1.2703E+03 | −4.7248E+02 |
| S4 | −1.1788E+02 | 2.9113E+02 | −3.4676E+02 | 1.6373E+02 |
| S5 | 5.3008E+02 | −7.0788E+02 | 5.4543E+02 | −1.8441E+02 |
| S6 | 9.5288E+01 | −9.2295E+01 | 5.3236E+01 | −1.3600E+01 |
| S7 | −1.3315E+02 | 2.1061E+02 | −2.2612E+02 | 1.6150E+02 |
| S8 | 3.7854E+01 | −3.4198E+01 | 2.1172E+01 | −8.7864E+00 |
| S9 | 7.0393E−01 | −7.7829E−02 | −4.0853E−02 | 2.1085E−02 |
| S10 | 3.6339E−01 | −1.3454E−01 | 3.5334E−02 | −6.3955E−03 |

FIG. 3A shows a longitudinal aberration curve of the optical imaging lens assembly according to Embodiment 1 to represent deviation of a convergence focal point after light with different wavelengths passes through the lens. FIG. 3B shows an astigmatism curve of the optical imaging lens assembly according to Embodiment 1 to represent a tangential image surface curvature and a sagittal image surface curvature. FIG. 3C shows a distortion curve of the optical imaging lens assembly according to Embodiment 1 to represent distortion values corresponding to different image heights. FIG. 3D shows a lateral color curve of the optical imaging lens assembly according to Embodiment 1 to represent deviation of different image heights on the imaging surface after the light passes through the lens. According to FIGS. 3A-3D, it can be seen that the optical imaging lens assembly provided in Embodiment 1 may achieve high imaging quality.

### Embodiment 2

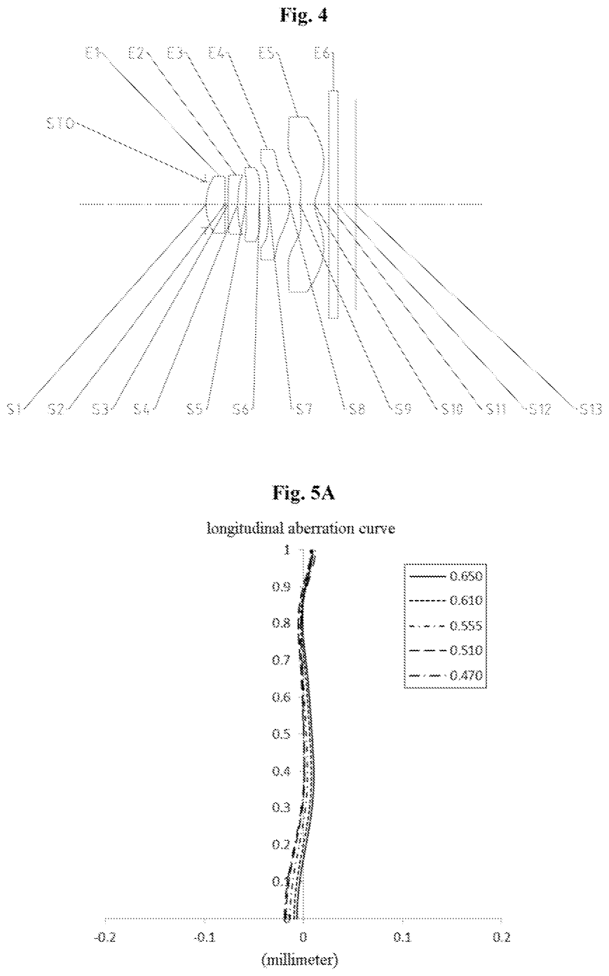

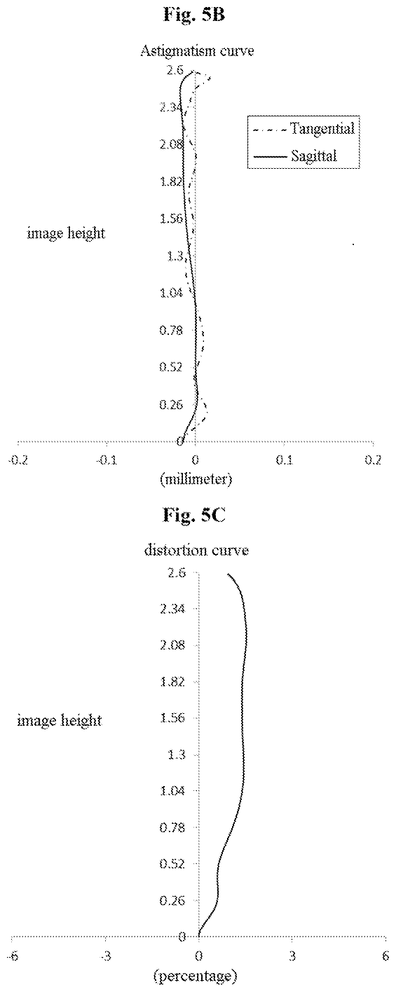

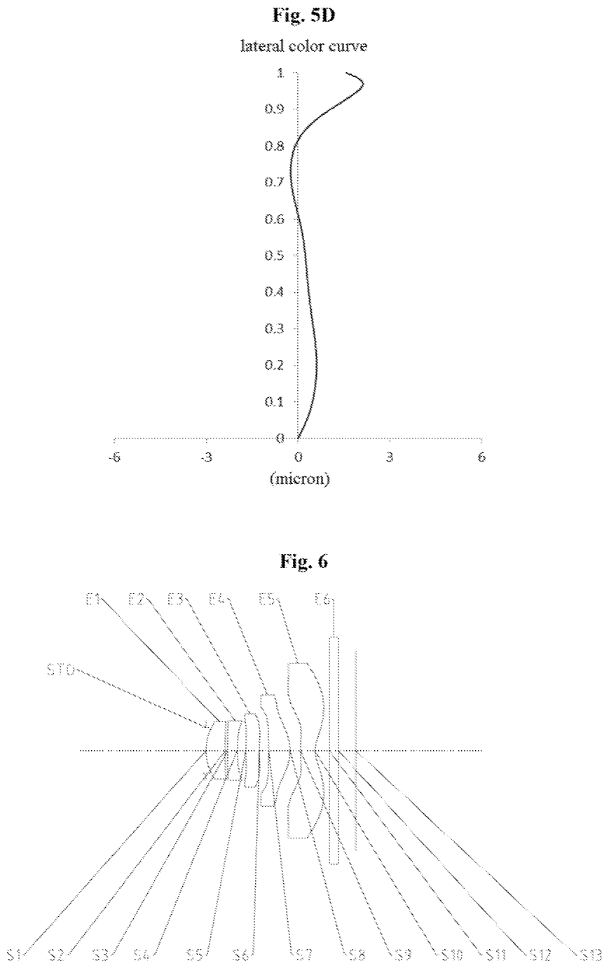

An optical imaging lens assembly according to Embodiment 2 of the disclosure will be described below with reference to FIGS. 4-5D. In the present embodiment and the following embodiments, part of the description similar to Embodiment 1 will be omitted for the sake of brevity. FIG. 4 shows a structure diagram of an optical imaging lens assembly according to Embodiment 2 of the disclosure.

As shown in FIG. 4, the optical imaging lens assembly sequentially includes, from an object side to an image side along an optical axis, a diaphragm STO, a first lens E1, a second lens E2, a third lens E3, a fourth lens E4, a fifth lens E5 and an optical filter E6.

The first lens E1 has a positive refractive power, an object-side surface S1 thereof is a convex surface, while an image-side surface S2 is a concave surface. The second lens E2 has a negative refractive power, an object-side surface S3 thereof is a convex surface, while an image-side surface S4 is a concave surface. The third lens E3 has a positive refractive power, an object-side surface S5 thereof is a convex surface, while an image-side surface S6 is a concave surface. The fourth lens E4 has a positive refractive power, an object-side surface S7 thereof is a concave surface, while an image-side surface S8 is a convex surface. The fifth lens E5 has a negative refractive power, an object-side surface S9 thereof is a convex surface, while an image-side surface S10 is a concave surface. The optical filter E6 has an object-side surface S11 and an image-side surface S12. The optical imaging lens assembly has an imaging surface S13. Light from an object sequentially penetrates through each of the surfaces S1 to S12 and is finally imaged on the imaging surface S13.

In Embodiment 2, a value of a total effective focal length f of the optical imaging lens assembly is 2.81 mm, TTL is an on-axis distance from the object-side surface S1 of the first lens E1 to the imaging surface S13, a value of TTL is 3.57 mm, and a value of ImgH (ImgH is a half of a diagonal length of an effective pixel region on the imaging surface S13) is 2.59 mm.

Table 3 shows a table of basic parameters for the optical imaging lens assembly of Embodiment 2, wherein the units of the curvature radius, the thickness/distance, and the focal length are all millimeter (mm). Table 4 shows higher order term coefficients that may be used for each aspheric mirror surface in Embodiment 2. A surface type of each aspheric surface may be defined by the formula (1) given in Embodiment 1.

TABLE 3

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | 370.0000 | | | | |
| STO | Spherical | Infinite | 0.0210 | | | | |
| S1 | Aspheric | 1.2996 | 0.4553 | 1.55 | 56.1 | 2.76 | −2.1291 |
| S2 | Aspheric | 8.3068 | 0.0741 | | | | 57.8989 |
| S3 | Aspheric | 12.5926 | 0.2250 | 1.68 | 19.2 | −5.47 | 89.9569 |
| S4 | Aspheric | 2.8437 | 0.1975 | | | | −0.6078 |
| S5 | Aspheric | 3.7378 | 0.3200 | 1.55 | 56.1 | 61.14 | 8.2864 |
| S6 | Aspheric | 4.0819 | 0.2205 | | | | −13.9923 |
| S7 | Aspheric | −10.4644 | 0.5017 | 1.54 | 55.7 | 2.54 | 0.0000 |
| S8 | Aspheric | −1.2258 | 0.2452 | | | | −0.8176 |
| S9 | Aspheric | 1.3941 | 0.3500 | 1.54 | 55.7 | −2.44 | −40.3625 |
| S10 | Aspheric | 0.6166 | 0.3399 | | | | −5.1104 |
| S11 | Spherical | Infinite | 0.2100 | 1.52 | 64.2 | | |
| S12 | Spherical | Infinite | 0.4295 | | | | |
| S13 | Spherical | Infinite | | | | | |

TABLE 4

| Surface | | | | | |
|---|---|---|---|---|---|
| number | A4 | A6 | A8 | A10 | A12 |
| S1 | 9.8635E−02 | 2.1867E−01 | −3.3113E+00 | 2.5624E+01 | −1.2942E+02 |
| S2 | −2.6392E−01 | 1.5629E+00 | −2.9277E+01 | 4.0966E+02 | −3.8093E+03 |
| S3 | −3.6919E−01 | 3.2217E+00 | −3.6772E+01 | 2.9667E+02 | −1.3685E+03 |
| S4 | −2.0588E−01 | 9.7349E−01 | 2.7040E+00 | −6.4745E+01 | 5.0206E+02 |
| S5 | −2.7658E−01 | −4.8665E+00 | 9.7125E+01 | −1.1363E+03 | 8.9424E+03 |
| S6 | 2.9617E−03 | −5.1010E+00 | 5.6241E+01 | −4.1660E+02 | 2.1660E+03 |
| S7 | 1.2020E−01 | 1.5622E+00 | −3.2459E+01 | 2.5931E+02 | −1.2725E+03 |
| S8 | −2.6945E−01 | 4.5001E+00 | −2.9296E+01 | 1.1648E+02 | −3.0486E+02 |
| S9 | −4.2352E−01 | −3.2920E−01 | 1.9663E+00 | −4.0539E+00 | 5.3345E+00 |
| S10 | −2.7251E−01 | 1.6195E−01 | 7.1232E−02 | −3.2274E−01 | 4.2852E−01 |

| Surface | | | | |
|---|---|---|---|---|
| number | A14 | A16 | A18 | A20 |
| S1 | 4.2942E+02 | −9.0660E+02 | 1.0964E+03 | −5.7272E+02 |
| S2 | 2.3714E+04 | −1.0040E+05 | 2.9068E+05 | −5.6671E+05 |
| S3 | 2.4111E+03 | 8.6197E+03 | −6.4776E+04 | 1.8261E+05 |
| S4 | −2.4308E+03 | 8.2680E+03 | −2.0555E+04 | 3.7138E+04 |
| S5 | −4.9175E+04 | 1.9234E+05 | −5.3785E+05 | 1.0670E+06 |
| S6 | −8.0768E+03 | 2.1818E+04 | −4.2678E+04 | 5.9711E+04 |
| S7 | 4.2513E+03 | −1.0137E+04 | 1.7673E+04 | −2.2704E+04 |
| S8 | 5.4381E+02 | −6.7239E+02 | 5.8064E+02 | −3.4901E+02 |
| S9 | −4.6928E+00 | 2.8210E+00 | −1.1757E+00 | 3.3995E−01 |
| S10 | −3.4772E−01 | 1.9110E−01 | −7.3061E−02 | 1.9417E−02 |

FIG. 5A shows a longitudinal aberration curve of the optical imaging lens assembly according to Embodiment 2 to represent deviation of a convergence focal point after light with different wavelengths passes through the lens. FIG. 5B shows an astigmatism curve of the optical imaging lens assembly according to Embodiment 2 to represent a tangential image surface curvature and a sagittal image surface curvature. FIG. 50 shows a distortion curve of the optical imaging lens assembly according to Embodiment 2 to represent distortion values corresponding to different image heights. FIG. 5D shows a lateral color curve of the optical imaging lens assembly according to Embodiment 2 to represent deviation of different image heights on the imaging surface after the light passes through the lens. According to FIGS. 5A-5D, it can be seen that the optical imaging lens assembly provided in Embodiment 2 may achieve high imaging quality.

### Embodiment 3

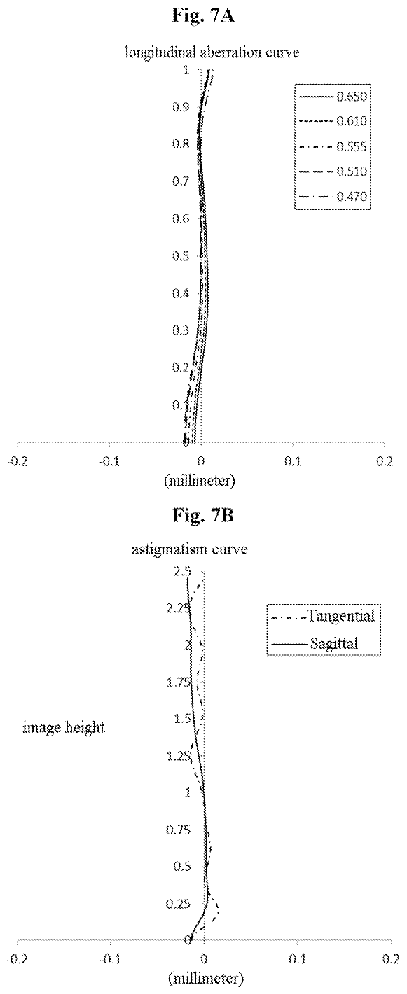

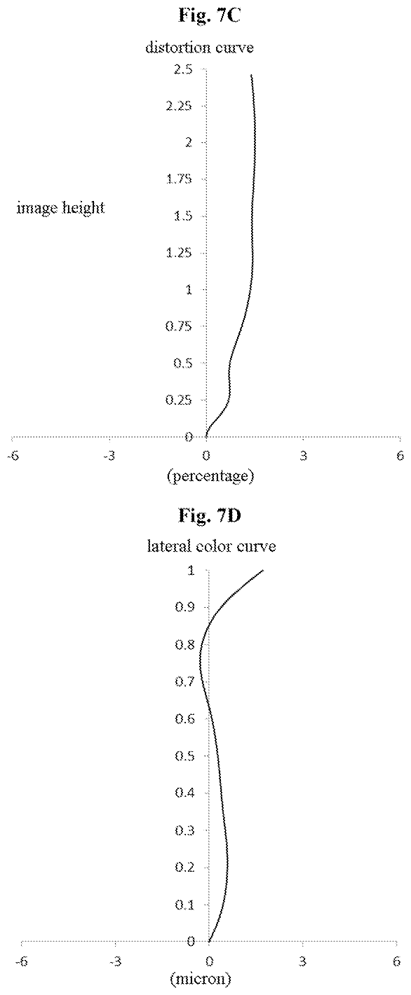

An optical imaging lens assembly according to Embodiment 3 of the disclosure is described below with reference to FIGS. 6-7D. FIG. 6 is a structure diagram of an optical imaging lens assembly according to Embodiment 3 of the disclosure.

As shown in FIG. 6, the optical imaging lens assembly sequentially includes, from an object side to an image side along an optical axis, a diaphragm STO, a first lens E1, a second lens E2, a third lens E3, a fourth lens E4, a fifth lens E5 and an optical filter E6.

The first lens E1 has a positive refractive power, an object-side surface S1 thereof is a convex surface, while an image-side surface S2 is a concave surface. The second lens E2 has a negative refractive power, an object-side surface S3 thereof is a convex surface, while an image-side surface S4 is a concave surface. The third lens E3 has a positive refractive power, an object-side surface S5 thereof is a convex surface, while an image-side surface S6 is a concave surface. The fourth lens E4 has a positive refractive power, an object-side surface S7 thereof is a concave surface, while an image-side surface S8 is a convex surface. The fifth lens E5 has a negative refractive power, an object-side surface S9 thereof is a convex surface, while an image-side surface S10 is a concave surface. The optical filter E6 has an object-side surface S11 and an image-side surface S12. The optical imaging lens assembly has an imaging surface S13. Light from an object sequentially penetrates through each of the surfaces S1 to S12 and is finally imaged on the imaging surface S13.

In Embodiment 3, a value of a total effective focal length f of the optical imaging lens assembly is 2.82 mm, TTL is an on-axis distance from the object-side surface S1 of the first lens E1 to the imaging surface S13, a value of TTL is 3.57 mm, and a value of ImgH (ImgH is a half of a diagonal length of an effective pixel region on the imaging surface S13) is 2.46 mm.

Table 5 shows a table of basic parameters for the optical imaging lens assembly of Embodiment 3, wherein the units of the curvature radius, the thickness/distance, and the focal length are all millimeter (mm). Table shows higher order term coefficients that may be used for each aspheric mirror surface in Embodiment 3, wherein each aspheric surface type can be defined by formula (1) given in Embodiment 1 above.

TABLE 5

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | 370.0000 | | | | |
| STO | Spherical | Infinite | −0.0010 | | | | |
| S1 | Aspheric | 1.2644 | 0.4594 | 1.55 | 56.1 | 2.69 | −1.9254 |
| S2 | Aspheric | 7.9739 | 0.0571 | | | | 86.1432 |
| S3 | Aspheric | 14.1282 | 0.2268 | 1.68 | 19.2 | −5.36 | 89.9707 |
| S4 | Aspheric | 2.8699 | 0.2069 | | | | 1.2469 |
| S5 | Aspheric | 4.3879 | 0.3200 | 1.55 | 56.1 | 93.43 | 11.7583 |
| S6 | Aspheric | 4.6773 | 0.2246 | | | | −13.9791 |
| S7 | Aspheric | −10.6902 | 0.5071 | 1.54 | 55.7 | 2.49 | 0.0000 |
| S8 | Aspheric | −1.2105 | 0.2451 | | | | −0.8326 |
| S9 | Aspheric | 1.4504 | 0.3500 | 1.54 | 55.7 | −2.35 | −49.9113 |
| S10 | Aspheric | 0.6178 | 0.3411 | | | | −5.3547 |
| S11 | Spherical | Infinite | 0.2100 | 1.52 | 64.2 | | |
| S12 | Spherical | Infinite | 0.4206 | | | | |
| S13 | Spherical | Infinite | | | | | |

TABLE 6

| Surface | | | | | |
|---|---|---|---|---|---|
| number | A4 | A6 | A8 | A10 | A12 |
| S1 | 1 0814E−01 | 1.9471E−01 | −3.0020E+00 | 2.6654E+01 | −1.5353E+02 |
| S2 | −3.3610E−01 | 2.7850E+00 | −4.5759E+01 | 6.0425E+02 | −5.6348E+03 |
| S3 | −3.8926E−01 | 3.3692E+00 | −3.6910E+01 | 3.2972E+02 | −2.0525E+03 |
| S4 | −1.7583E−01 | 7.4869E−01 | 5.6769E+00 | −9.0505E+01 | 6.5685E+02 |
| S5 | −3.3130E−01 | −2.1917E+00 | 4.6268E+01 | −5.6051E+02 | 4.6667E+03 |
| S6 | −9.7460E−02 | −2.5372E+00 | 2.3564E+01 | −1.6527E+02 | 8.8088E+02 |
| S7 | 9.8541E−02 | 1.7954E+00 | −2.8966E+01 | 1.8970E+02 | −7.3088E+02 |
| S8 | −3.1781E−01 | 5.1908E+00 | −3.3939E+01 | 1.3560E+02 | −3.5712E+02 |
| S9 | −4.7431E−01 | −1.8224E−01 | 1.5396E+00 | −3.0423E+00 | 3.8083E+00 |
| S10 | −2.7395E−01 | 1.5643E−01 | 7.0307E−02 | −2.6059E−01 | 2.9091E−01 |

| Surface | | | | |
|---|---|---|---|---|
| number | A14 | A16 | A18 | A20 |
| S1 | 5.6925E+02 | −1.2971E+03 | 1.6368E+03 | −8.6926E+02 |
| S2 | 3.6409E+04 | −1.6317E+05 | 5.0518E+05 | −1.0568E+06 |
| S3 | 8.7767E+03 | −2.6191E+04 | 5.6396E+04 | −8.8983E+04 |
| S4 | −3.1494E+03 | 1.0932E+04 | −2.8247E+04 | 5.3472E+04 |
| S5 | −2.7337E+04 | 1.1376E+05 | −3.3709E+05 | 7.0514E+05 |
| S6 | −3.5041E+03 | 1.0261E+04 | −2.1853E+04 | 3.3257E+04 |
| S7 | 1.7449E+03 | −2.4291E+03 | 1.2108E+03 | 2.1052E+03 |
| S8 | 6.4235E+02 | −8.0201E+02 | 6.9974E+02 | −4.2485E+02 |
| S9 | −3.1883E+00 | 1.8064E+00 | −6.9655E−01 | 1.8126E−01 |
| S10 | −1.9564E−01 | 8.7801E−02 | −2.6935E−02 | 5.5939E−03 |

FIG. 7A shows a longitudinal aberration curve of the optical imaging lens assembly according to Embodiment 3 to represent deviation of a convergence focal point after light with different wavelengths passes through the lens. FIG. 7B shows an astigmatism curve of the optical imaging lens assembly according to Embodiment 3 to represent a tangential image surface curvature and a sagittal image surface curvature. FIG. 7C shows a distortion curve of the optical imaging lens assembly according to Embodiment 3 to represent distortion values corresponding to different image heights. FIG. 7D shows a lateral color curve of the optical imaging lens assembly according to Embodiment 3 to represent deviation of different image heights on the imaging surface after the light passes through the lens. According to FIGS. 7A-7D, it can be seen that the optical imaging lens assembly provided in Embodiment 3 may achieve high imaging quality.

### Embodiment 4

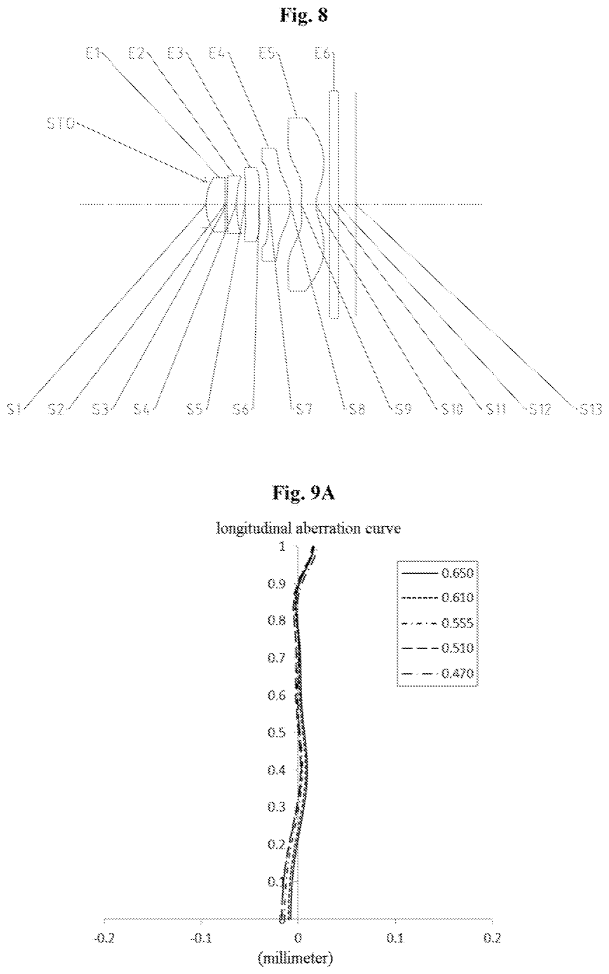

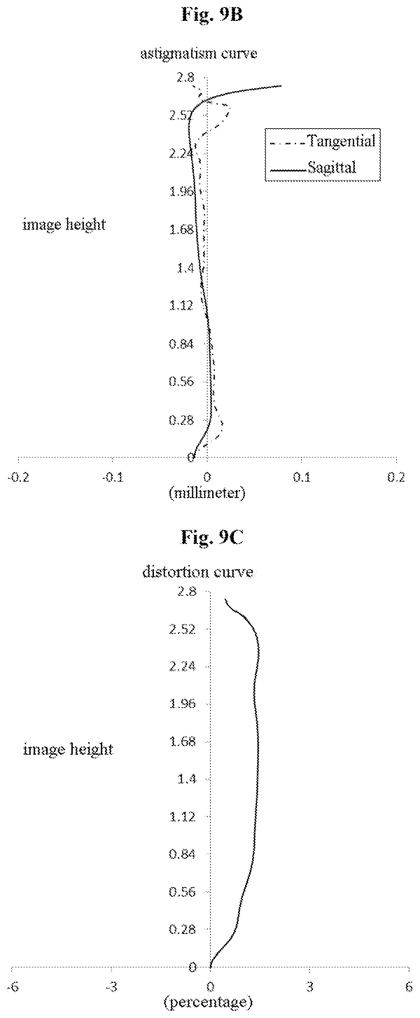

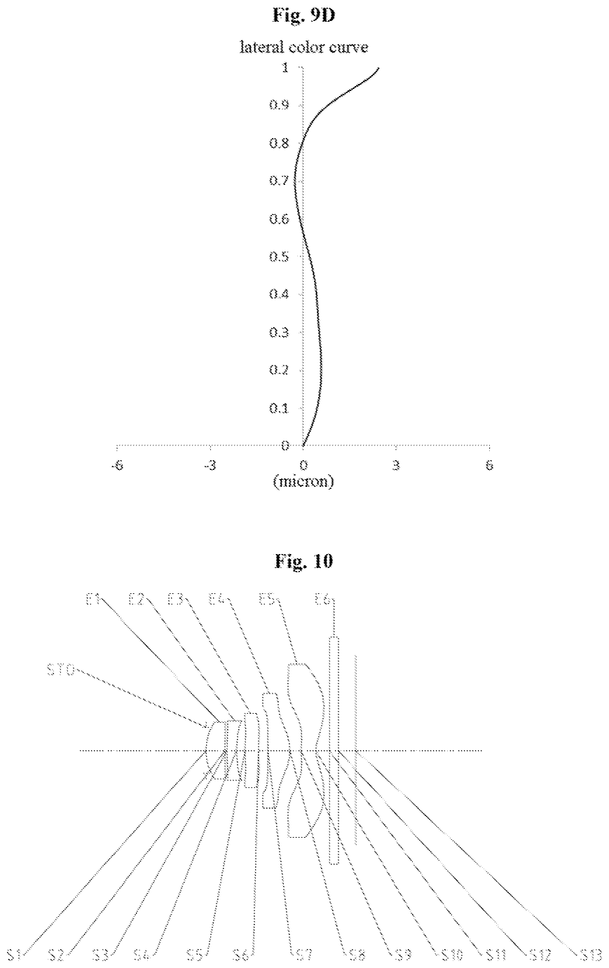

An optical imaging lens assembly according to Embodiment 4 of the disclosure is described below with reference to FIGS. 8-9D. FIG. 8 is a structure diagram of an optical imaging lens assembly according to Embodiment 4 of the disclosure.

As shown in FIG. 8, the optical imaging lens assembly sequentially includes, from an object side to an image side along an optical axis, a diaphragm STO, a first lens E1, a second lens E2, a third lens E3, a fourth lens E4, a fifth lens E5 and an optical filter E6.

The first lens E1 has a positive refractive power, an object-side surface S1 thereof is a convex surface, while an image-side surface S2 is a concave surface. The second lens E2 has a negative refractive power, an object-side surface S3 thereof is a convex surface, while an image-side surface S4 is a concave surface. The third lens E3 has a negative refractive power, an object-side surface S5 thereof is a convex surface, while an image-side surface S6 is a concave surface. The fourth lens E4 has a positive refractive power, an object-side surface S7 thereof is a concave surface, while an image-side surface S8 is a convex surface. The fifth lens E5 has a negative refractive power, an object-side surface S9 thereof is a convex surface, while an image-side surface S10 is a concave surface. The optical filter E6 has an object-side surface S11 and an image-side surface S12. The optical imaging lens assembly has an imaging surface S13. Light from an object sequentially penetrates through each of the surfaces S1 to S12 and is finally imaged on the imaging surface S13.

In Embodiment 4, a value of a total effective focal length f of the optical imaging lens assembly is 2.82 mm, TTL is an on-axis distance from the object-side surface S1 of the first lens E1 to the imaging surface S13, a value of TTL is 3.57 mm, and a value of ImgH (ImgH is a half of a diagonal length of an effective pixel region on the imaging surface S13) is 2.74 mm.

Table 7 shows a table of basic parameters for the optical imaging lens assembly of Embodiment 4, wherein the units of the curvature radius, the thickness/distance, and the focal length are all millimeter (mm). Table 8 shows higher order term coefficients that may be used for each aspheric mirror surface in Embodiment 4, wherein each aspheric surface type can be defined by formula (1) given in Embodiment 1 above.

TABLE 7

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | 370.0000 | | | | |
| STO | Spherical | Infinite | 0.0200 | | | | |
| S1 | Aspheric | 1.2830 | 0.4568 | 1.55 | 56.1 | 2.64 | −2.0097 |
| S2 | Aspheric | 10.2664 | 0.0427 | | | | 88.6973 |
| S3 | Aspheric | 11.5829 | 0.2250 | 1.68 | 19.2 | −5.12 | 89.8381 |
| S4 | Aspheric | 2.6505 | 0.2071 | | | | 1.1963 |
| S5 | Aspheric | 3.7826 | 0.3316 | 1.55 | 56.1 | −136.41 | 11.0901 |
| S6 | Aspheric | 3.4883 | 0.2270 | | | | −18.2490 |
| S7 | Aspheric | −74.5822 | 0.5170 | 1.54 | 55.7 | 2.30 | 0.0000 |
| S8 | Aspheric | −1.2178 | 0.2606 | | | | −1.0570 |
| S9 | Aspheric | 1.8873 | 0.3500 | 1.54 | 55.7 | −2.21 | −84.0983 |
| S10 | Aspheric | 0.6824 | 0.3204 | | | | −5.1727 |
| S11 | Spherical | Infinite | 0.2100 | 1.52 | 64.2 | | |
| S12 | Spherical | Infinite | 0.4217 | | | | |
| S13 | Spherical | Infinite | | | | | |

TABLE 8

| Surface | | | | | |
|---|---|---|---|---|---|
| number | A4 | A6 | A8 | A10 | A12 |
| S1 | 1.1938E−01 | −4.2015E−01 | 8.0695E+00 | −8.1223E+01 | 4.5961E+02 |
| S2 | −3.2833E−01 | 1.7697E+00 | 1.1938E+01 | −5.2154E+02 | 6.7789E+03 |
| S3 | −3.2573E−01 | 7.5338E−01 | 4.9050E+01 | −1.0687E+03 | 1.1694E+04 |
| S4 | −1.2361E−01 | −7.5069E−01 | 3.6451E+01 | −4.5709E+02 | 3.4346E+03 |
| S5 | −3.9412E−01 | −1.9705E+00 | 4.6730E+01 | −5.7574E+02 | 4.8556E+03 |
| S6 | −1.7608E−01 | −2.2380E+00 | 2.1546E+01 | −1.2700E+02 | 5.2857E+02 |
| S7 | −8.3503E−02 | 3.3465E+00 | −4.9966E+01 | 3.7793E+02 | −1.7986E+03 |
| S8 | −2.3458E−01 | 3.8946E+00 | −2.9092E+01 | 1.3064E+02 | −3.8193E+02 |
| S9 | −4.2567E−01 | −1.0658E+00 | 4.7706E+00 | −8.7044E+00 | 9.8111E+00 |
| S10 | −3.4951E−01 | 2.4982E−01 | 8.5575E−02 | −3.8684E−01 | 4.2305E−01 |

| Surface | | | | |
|---|---|---|---|---|
| number | A14 | A16 | A18 | A20 |
| S1 | −1.5296E+03 | 2.9539E+03 | −3.0440E+03 | 1.2854E+03 |
| S2 | −5.0182E+04 | 2.3431E+05 | −7.0839E+05 | 1.3789E+06 |
| S3 | −7.9394E+04 | 3.5346E+05 | −1.0465E+06 | 2.0400E+06 |
| S4 | −1.7324E+04 | 6.0622E+04 | −1.4776E+05 | 2.4683E+05 |
| S5 | −2.8983E+04 | 1.2321E+05 | −3.7247E+05 | 7.9229E+05 |
| S6 | −1.6439E+03 | 3.9279E+03 | −7.2760E+03 | 1.0309E+04 |
| S7 | 5.8454E+03 | −1.3482E+04 | 2.2468E+04 | −2.7173E+04 |
| S8 | 7.6895E+02 | −1.0952E+03 | 1.1175E+03 | −8.1927E+02 |
| S9 | −7.4445E+00 | 3.9273E+00 | −1.4561E+00 | 3.7720E−01 |
| S10 | −2.6877E−01 | 1.1192E−01 | −3.1501E−02 | 5.9643E−03 |

FIG. 9A shows a longitudinal aberration curve of the optical imaging lens assembly according to Embodiment 4 to represent deviation of a convergence focal point after light with different wavelengths passes through the lens. FIG. 9B shows an astigmatism curve of the optical imaging lens assembly according to Embodiment 4 to represent a tangential image surface curvature and a sagittal image surface curvature. FIG. 9C shows a distortion curve of the optical imaging lens assembly according to Embodiment 4 to represent distortion values corresponding to different image heights. FIG. 9D shows a lateral color curve of the optical imaging lens assembly according to Embodiment 4 to represent deviation of different image heights on the imaging surface after the light passes through the lens. According to FIGS. 9A-9D, it can be seen that the optical imaging lens assembly provided in Embodiment 4 may achieve high imaging quality.

### Embodiment 5

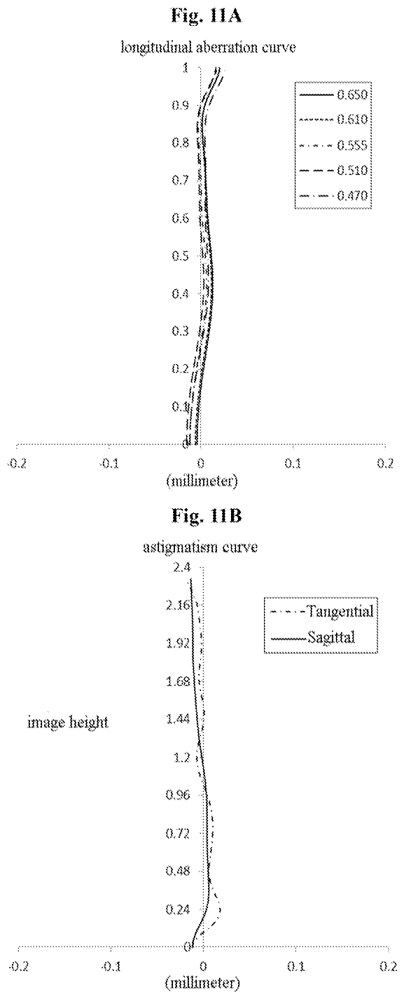

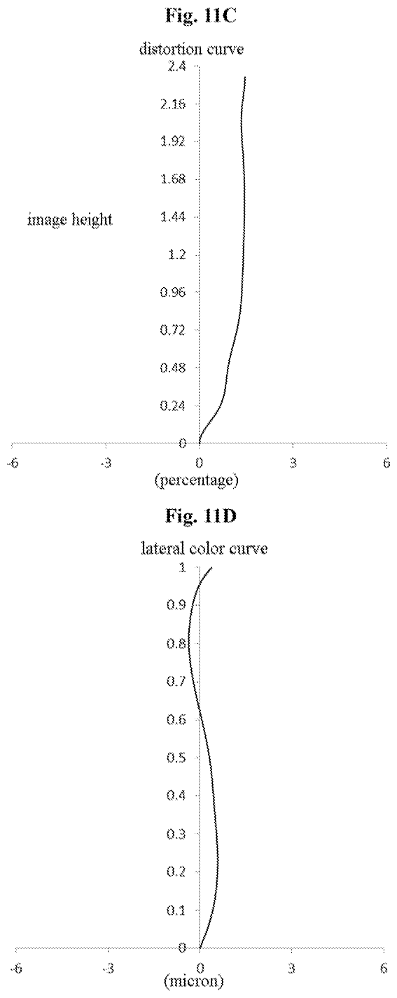

An optical imaging lens assembly according to Embodiment 5 of the disclosure is described below with reference to FIGS. 10-11D. FIG. 10 is a structure diagram of an optical imaging lens assembly according to Embodiment 5 of the disclosure.

As shown in FIG. 10, the optical imaging lens assembly sequentially includes, from an object side to an image side along an optical axis, a diaphragm STO, a first lens E1, a second lens E2, a third lens E3, a fourth lens E4, a fifth lens E5 and an optical filter E6.

The first lens E1 has a positive refractive power, an object-side surface S1 thereof is a convex surface, while an image-side surface S2 is a concave surface. The second lens E2 has a negative refractive power, an object-side surface S3 thereof is a convex surface, while an image-side surface S4 is a concave surface. The third lens E3 has a negative refractive power, an object-side surface S5 thereof is a convex surface, while an image-side surface S6 is a concave surface. The fourth lens E4 has a positive refractive power, an object-side surface S7 thereof is a convex surface, while an image-side surface S8 is a convex surface. The fifth lens E5 has a negative refractive power, an object-side surface S9 thereof is a convex surface, while an image-side surface S10 is a concave surface. The optical filter E6 has an object-side surface S11 and an image-side surface S12. The optical imaging lens assembly has an imaging surface S13. Light from an object sequentially penetrates through each of the surfaces S1 to S12 and is finally imaged on the imaging surface S13.

In Embodiment 5, a value of a total effective focal length f of the optical imaging lens assembly is 2.82 mm, TTL is an on-axis distance from the object-side surface S1 of the first lens E1 to the imaging surface S13, a value of TTL is 3.57 mm, and a value of ImgH (ImgH is a half of a diagonal length of an effective pixel region on the imaging surface S13) is 2.33 mm.

Table 9 shows a table of basic parameters for the optical imaging lens assembly of Embodiment 5, wherein the units of the curvature radius, the thickness/distance, and the focal length are all millimeter (mm). Table 10 shows higher order term coefficients that may be used for each aspheric mirror surface in Embodiment 5, wherein each aspheric surface type can be defined by formula (1) given in Embodiment 1 above.

TABLE 9

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | 370.0000 | | | | |
| STO | Spherical | Infinite | −0.0100 | | | | |
| S1 | Aspheric | 1.2837 | 0.4531 | 1.55 | 56.1 | 2.69 | −1.9894 |
| S2 | Aspheric | 8.9581 | 0.0485 | | | | 82.7167 |
| S3 | Aspheric | 12.5157 | 0.2250 | 1.68 | 19.2 | −5.23 | 88.6861 |
| S4 | Aspheric | 2.7407 | 0.2031 | | | | 1.1709 |
| S5 | Aspheric | 3.4364 | 0.3180 | 1.54 | 56.1 | −98.79 | 9.8990 |
| S6 | Aspheric | 3.1249 | 0.2270 | | | | −18.8462 |
| S7 | Aspheric | 142.0559 | 0.5216 | 1.54 | 55.7 | 2.29 | 0.0000 |
| S8 | Aspheric | −1.2418 | 0.2678 | | | | −1.1255 |
| S9 | Aspheric | 1.8458 | 0.3500 | 1.54 | 55.7 | −2.25 | −75.6984 |
| S10 | Aspheric | 0.6818 | 0.3244 | | | | −5.1224 |
| S11 | Spherical | Infinite | 0.2100 | 1.52 | 64.2 | | |
| S12 | Spherical | Infinite | 0.4212 | | | | |
| S13 | Spherical | Infinite | | | | | |

TABLE 10

| Surface | | | | | |
|---|---|---|---|---|---|
| number | A4 | A6 | A8 | A10 | A12 |
| S1 | 9.5204E−02 | 7.1466E−01 | −1.5847E+01 | 2.0108E+02 | −1.5851E+03 |
| S2 | −3.0365E−01 | 2.5128E+00 | −1.4505E+01 | −1.0947E+02 | 2.7476E+03 |
| S3 | −2.9083E−01 | 1.1191E+00 | 3.3018E+01 | −8.2126E+02 | 9.2811E+03 |
| S4 | −1.2235E−01 | −5.8207E−01 | 3.3250E+01 | −4.2577E+02 | 3.2192E+03 |
| S5 | −4.0330E−01 | −2.8990E+00 | 6.9080E+01 | −8.6127E+02 | 7.1568E+03 |
| S6 | −2.0958E−01 | −1.4634E+00 | 1.0656E+01 | −2.6096E+01 | −9.0051E+01 |
| S7 | −1.0931E−01 | 3.8583E+00 | −5.4609E+01 | 4.0639E+02 | −1.9167E+03 |
| S8 | −2.2124E−01 | 3.5076E+00 | −2.5095E+01 | 1.0916E+02 | −3.0937E+02 |
| S9 | −4.4180E−01 | −8.9648E−01 | 4.2367E+00 | −7.6954E+00 | 8.4954E+00 |
| S10 | −3.5316E−01 | 2.7838E−01 | 3.4270E−02 | −3.5182E−01 | 4.3290E−01 |

| Surface | | | | |
|---|---|---|---|---|
| number | A14 | A16 | A18 | A20 |
| S1 | 7.9738E+03 | −2.5806E+04 | 5.2949E+04 | −6.5698E+04 |
| S2 | −2.3896E+04 | 1.1801E+05 | −3.5870E+05 | 6.7624E+05 |
| S3 | −6.3589E+04 | 2.8309E+05 | −8.3383E+05 | 1.6112E+06 |
| S4 | −1.6241E+04 | 5.6691E+04 | −1.3764E+05 | 2.2884E+05 |
| S5 | −4.1405E+04 | 1.6937E+05 | −4.9166E+05 | 1.0045E+06 |
| S6 | 9.5242E+02 | −3.7134E+03 | 8.6493E+03 | −1.3076E+04 |
| S7 | 6.1932E+03 | −1.4239E+04 | 2.3709E+04 | −2.8696E+04 |
| S8 | 6.0530E+02 | − 8.4084E+02 | 8.3976E+02 | −6.0421E+02 |
| S9 | −6.2362E+00 | 3.1446E+00 | −1.0986E+00 | 2.6293E−01 |
| S10 | −3.0724E−01 | 1.4658E−01 | −4.9245E−02 | 1.1775E−02 |

FIG. 11A shows a longitudinal aberration curve of the optical imaging lens assembly according to Embodiment 5 to represent deviation of a convergence focal point after light with different wavelengths passes through the lens. FIG. 11B shows an astigmatism curve of the optical imaging lens assembly according to Embodiment 5 to represent a tangential image surface curvature and a sagittal image surface curvature. FIG. 110C shows a distortion curve of the optical imaging lens assembly according to Embodiment 5 to represent distortion values corresponding to different image heights. FIG. 11D shows a lateral color curve of the optical imaging lens assembly according to Embodiment 5 to represent deviation of different image heights on the imaging surface after the light passes through the lens. According to FIGS. 11A-11D, it can be seen that the optical imaging lens assembly provided in Embodiment 5 may achieve high imaging quality.

### Embodiment 6

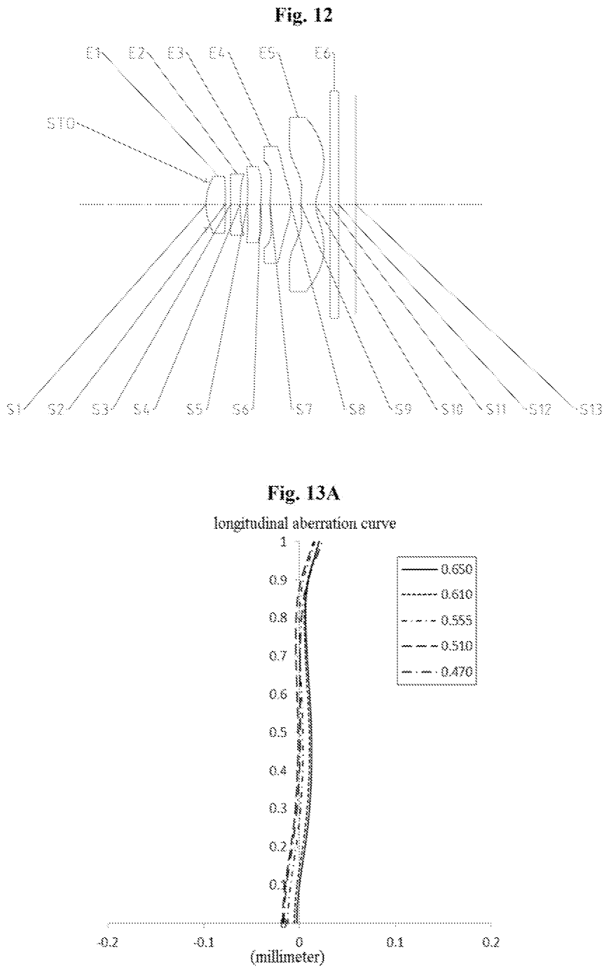

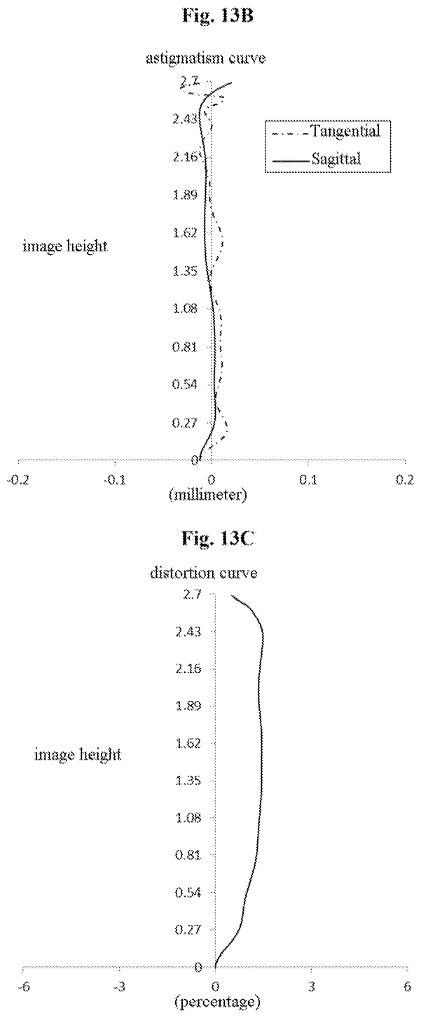

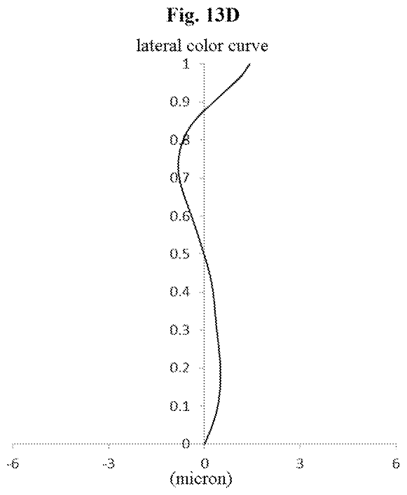

An optical imaging lens assembly according to Embodiment 6 of the disclosure is described below with reference to FIGS. 12-13D. FIG. 12 is a structure diagram of an optical imaging lens assembly according to Embodiment 6 of the disclosure.

As shown in FIG. 12, the optical imaging lens assembly sequentially includes, from an object side to an image side along an optical axis, a diaphragm STO, a first lens E1, a second lens E2, a third lens E3, a fourth lens E4, a fifth lens E5 and an optical filter E6.

The first lens E1 has a positive refractive power, an object-side surface S1 thereof is a convex surface, while an image-side surface S2 is a concave surface. The second lens E2 has a negative refractive power, an object-side surface S3 thereof is a concave surface, while an image-side surface S4 is a concave surface. The third lens E3 has a negative refractive power, an object-side surface S5 thereof is a convex surface, while an image-side surface S6 is a concave surface. The fourth lens E4 has a positive refractive power, an object-side surface S7 thereof is a convex surface, while an image-side surface S8 is a convex surface. The fifth lens E5 has a negative refractive power, an object-side surface S9 thereof is a convex surface, while an image-side surface S10 is a concave surface. The optical filter E6 has an object-side surface S11 and an image-side surface S12. The optical imaging lens assembly has an imaging surface S13. Light from an object sequentially penetrates through each of the surfaces S1 to S12 and is finally imaged on the imaging surface S13.

In Embodiment 6, a value of a total effective focal length f of the optical imaging lens assembly is 2.82 mm, TTL is an on-axis distance from the object-side surface S1 of the first lens E1 to the imaging surface S13, a value of TTL is 3.57 mm, and a value of ImgH (ImgH is a half of a diagonal length of an effective pixel region on the imaging surface S13) is 2.69 mm.

TABLE 11

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | 370.0000 | | | | |
| STO | Spherical | Infinite | −0.0100 | | | | |
| S1 | Aspheric | 1.3619 | 0.4585 | 1.55 | 56.1 | 2.83 | −2.6841 |
| S2 | Aspheric | 10.2511 | 0.1287 | | | | −99.0000 |
| S3 | Aspheric | −89.9385 | 0.2250 | 1.68 | 19.2 | −6.06 | 90.0000 |
| S4 | Aspheric | 4.3105 | 0.1722 | | | | −2.5819 |
| S5 | Aspheric | 3.3953 | 0.3180 | 1.54 | 56.1 | −27.83 | 9.1147 |
| S6 | Aspheric | 2.6830 | 0.2252 | | | | −44.0312 |
| S7 | Aspheric | 5.5198 | 0.4895 | 1.54 | 55.7 | 2.46 | 0.0000 |
| S8 | Aspheric | −1.6827 | 0.2400 | | | | −1.1255 |
| S9 | Aspheric | 1.4450 | 0.3500 | 1.54 | 55.7 | −2.58 | −40.6551 |
| S10 | Aspheric | 0.6480 | 0.3377 | | | | −4.4677 |
| S11 | Spherical | Infinite | 0.2100 | 1.52 | 64.2 | | |
| S12 | Spherical | Infinite | 0.4146 | | | | |
| S13 | Spherical | Infinite | | | | | |

TABLE 12

| Surface | | | | | |
|---|---|---|---|---|---|
| number | A4 | A6 | A8 | A10 | A12 |
| S1 | 9.5744E−02 | 3.2439E−01 | −8.9639E+00 | 1.0789E+02 | −7.6671E+02 |
| S2 | −6.4770E−02 | −2.2690E+00 | 3.8149E+01 | −4.4042E+02 | 3.3944E+03 |
| S3 | −6.7156E−02 | −1.3194E+00 | 3.0806E+01 | −4.6393E+02 | 4.4454E+03 |
| S4 | −4.3915E−02 | −1.2774E+00 | 3.6846E+01 | −4.5819E+02 | 3.5448E+03 |
| S5 | −3.9299E−01 | −4.1126E+00 | 8.6818E+01 | −9.3996E+02 | 6.7380E+03 |
| S6 | 2.3037E−02 | −6.4517E+00 | 7.2097E+01 | −5.0474E+02 | 2.4372E+03 |
| S7 | 9.2697E−02 | −1.2491E+00 | −6.2293E−01 | 4.4447E+01 | −2.5684E+02 |
| S8 | −2.0507E−01 | 2.3526E+00 | −1.6635E+01 | 7.3619E+01 | −2.0309E+02 |
| S9 | −3.8869E−01 | −2.0296E+00 | 9.0465E+00 | −1.8076E+01 | 2.2271E+01 |
| S10 | −4.6298E−01 | 4.7071E−01 | −6.5285E−02 | −4.9428E−01 | 7.4522E−01 |

| Surface | | | | |
|---|---|---|---|---|
| number | A14 | A16 | A18 | A20 |
| S1 | 3.1886E+03 | −7.0461E+03 | 4.0460E+03 | 1.6095E+04 |
| S2 | −1.8106E+04 | 6.7962E+04 | −1.7841E+05 | 3.1942E+05 |
| S3 | −2.7910E+04 | 1.1742E+05 | −3.3232E+05 | 6.2392E+05 |
| S4 | −1.8357E+04 | 6.5309E+04 | −1.5999E+05 | 2.6498E+05 |
| S5 | −3.3923E+04 | 1.2244E+05 | −3.1793E+05 | 5.8802E+05 |
| S6 | −8.4354E+03 | 2.1237E+04 | −3.8921E+04 | 5.1326E+04 |
| S7 | 8.1473E+02 | −1.7176E+03 | 2.5872E+03 | −2.8880E+03 |
| S8 | 3.7408E+02 | −4.8252E+02 | 4.4713E+02 | −3.0025E+02 |
| S9 | −1.8411E+01 | 1.0599E+01 | −4.3151E+00 | 1.2402E+00 |
| S10 | −5.9886E−01 | 3.1518E−01 | −1.1475E−01 | 2.9222E−02 |

FIG. 13A shows a longitudinal aberration curve of the optical imaging lens assembly according to Embodiment 6 to represent deviation of a convergence focal point after light with different wavelengths passes through the lens. FIG. 13B shows an astigmatism curve of the optical imaging lens assembly according to Embodiment 6 to represent a tangential image surface curvature and a sagittal image surface curvature. FIG. 130 shows a distortion curve of the optical imaging lens assembly according to Embodiment 6 to represent distortion values corresponding to different image heights. FIG. 13D shows a lateral color curve of the optical imaging lens assembly according to Embodiment 6 to represent deviation of different image heights on the imaging surface after the light passes through the lens. According to FIGS. 13A-13D, it can be seen that the optical imaging lens assembly provided in Embodiment 6 may achieve high imaging quality.

From the above, Embodiment 1 to Embodiment 6 meet a relationship shown in Table 13 respectively.

TABLE 13

| | embodiment | | | | | |
|---|---|---|---|---|---|---|
| Conditional expression | 1 | 2 | 3 | 4 | 5 | 6 |
| VP(mm) | 0.61 | 0.64 | 0.68 | 0.60 | 0.71 | 0.62 |
| TTL × | 4.63 | 4.92 | 5.18 | 4.65 | 5.47 | 4.74 |
| TTL/ImgH(mm) | | | | | | |
| FOV(°) | 87.1 | 83.9 | 80.5 | 87.2 | 77.5 | 86.1 |
| (f1 + f4)/f | 1.93 | 1.89 | 1.84 | 1.75 | 1.77 | 1.88 |
| f2/f5 | 3.70 | 2.24 | 2.28 | 2.31 | 2.32 | 2.35 |
| R5/R9 | 2.25 | 2.68 | 3.03 | 2.00 | 1.86 | 2.35 |
| f/R10 | 4.15 | 4.55 | 4.56 | 4.13 | 4.13 | 4.35 |
| TTL (mm) | 3.56 | 3.57 | 3.57 | 3.57 | 3.57 | 3.57 |
| CT 4/(T45 + CT5) | 0.94 | 0.84 | 0.85 | 0.85 | 0.84 | 0.83 |
| (DT11 + DT12)/ImgH | 0.52 | 0.53 | 0.56 | 0.49 | 0.59 | 0.51 |
| SL/TTL | 1.01 | 1.01 | 0.9997 | 1.01 | 0.997 | 0.997 |
| SAG42/SAG41 | 1.98 | 2.06 | 2.07 | 2.26 | 2.58 | 2.13 |
| f123/(CT1 + CT2 + | 4.22 | 4.21 | 4.16 | 4.35 | 4.56 | 4.85 |
| CT3) | | | | | | |
| (ET4 + ET5)/(CT4 + | 0.86 | 0.87 | 0.87 | 0.84 | 0.83 | 0.85 |
| CT5) | | | | | | |
| DW(mm) | 1.16 | 1.15 | 1.15 | 1.15 | 1.15 | 1.15 |

The disclosure also provides an imaging device, which is provided with an electronic photosensitive element for imaging. The electronic photosensitive element may be a Charge Coupled Device (CCD) or a Complementary Metal Oxide Semiconductor (CMOS). The imaging device may be an independent imaging device such as a digital camera, and may also be an imaging module integrated into a mobile electronic device such as a mobile phone. The imaging device is provided with the abovementioned optical imaging lens assembly.

The above description is only description about the preferred embodiments of the disclosure and adopted technical principles. It is understood by those skilled in the art that the scope of protection involved in the disclosure is not limited to the technical solutions formed by specifically combining the technical characteristics and should also cover other technical solutions formed by freely combining the technical characteristics or equivalent characteristics thereof without departing from the concept of the disclosure, for example, technical solutions formed by mutually replacing the characteristics and (but not limited to) the technical characteristics with similar functions disclosed in the disclosure.

What is claimed is:

1. An optical imaging lens assembly, sequentially comprising, from an object side to an image side along an optical axis:
a first lens with a positive refractive power;
a second lens with a negative refractive power;
a third lens with a refractive power, an object-side surface thereof is a convex surface;
a fourth lens with a positive refractive power; and
a fifth lens with a negative refractive power, an object-side surface thereof is a convex surface,
wherein an on-axis distance VP from an intersection point of a straight line where a marginal ray of the optical imaging lens assembly and the optical axis to an object-side surface of the first lens satisfies:
0 mm<VP<0.8 mm.

2. The optical imaging lens assembly according to claim 1, wherein TTL is a spacing distance from the object-side surface of the first lens to an imaging surface of the optical imaging lens assembly on the optical axis, and ImgH is a half of a diagonal length of an effective pixel region on the imaging surface of the optical imaging lens assembly, TTL and ImgH satisfy:
4.5 mm<TTL×TTL/ImgH<5.5 mm.

3. The optical imaging lens assembly according to claim 1, wherein a maximum field of view (FOV) of the optical imaging lens assembly satisfies:
70°<FOV<90°.

4. The optical imaging lens assembly according to claim 1, wherein an effective focal length f1 of the first lens, an effective focal length f4 of the fourth lens and a total effective focal length f of the optical imaging lens assembly satisfy:
1.6<(f1+f4)/f<2.1.

5. The optical imaging lens assembly according to claim 1, wherein an effective focal length f2 of the second lens and an effective focal length f5 of the fifth lens satisfy:
2.2<f2/f5<3.8.

6. The optical imaging lens assembly according to claim 1, wherein a curvature radius R5 of an object-side surface of the third lens and a curvature radius R9 of an image-side surface of the fifth lens satisfy:
1.8<R5/R9<3.1.

7. The optical imaging lens assembly according to claim 1, wherein a total effective focal length f of the optical imaging lens assembly and a curvature radius R10 of an image-side surface of the fifth lens satisfy:
4.1<f/R10<4.6.

8. The optical imaging lens assembly according to claim 1, wherein TTL is a spacing distance from the object-side surface of the first lens to an imaging surface of the optical imaging lens assembly on the optical axis, TTL satisfies:
3.0 mm<TTL<4.0 mm.

9. The optical imaging lens assembly according to claim 1, VP and a maximum field of view (FOV) of the optical imaging lens assembly satisfy:
1.0 mm<2×VP×tan(FOV/2)<1.5 mm.

10. The optical imaging lens assembly according to claim 1, wherein a center thickness CT4 of the fourth lens on the optical axis, a spacing distance T45 of the fourth lens and the fifth lens on the optical axis and a center thickness CT5 of the fifth lens on the optical axis satisfy:
0.7<CT41(T45+CT5)<1.0.

11. The optical imaging lens assembly according to claim 1, wherein ImgH is a half of the diagonal length of the effective pixel region on an imaging surface of the optical imaging lens assembly, an effective radius DT11 of the object-side surface of the first lens, an effective radius DT12 of an image-side surface of the first lens and ImgH satisfy:
0.4<(DT11+DT12)/ImgH<0.6.

12. The optical imaging lens assembly according to claim 1, further comprising a diaphragm, wherein SL is a spacing distance from the diaphragm to an imaging surface of the optical imaging lens assembly on the optical axis, and TTL is a spacing distance from the object-side surface of the first lens to the imaging surface of the optical imaging lens assembly on the optical axis, TTL and SL satisfy:
SL/TTL>0.9.

13. The optical imaging lens assembly according to claim 1, wherein SAG42 is an on-axis distance from an intersection point of an image-side surface of the fourth lens and the optical axis to an effective radius vertex of the image-side surface of the fourth lens, and SAG41 is an on-axis distance from an intersection point of an object-side surface of the fourth lens and the optical axis to an effective radius vertex of the object-side surface of the fourth lens, SAG42 and SAG41 satisfy:
1.8<SAG42/SAG41<2.6.

14. The optical imaging lens assembly according to claim 1, wherein a combined focal length f123 of the first lens, the second lens and the third lens, a center thickness CT1 of the first lens on the optical axis, a center thickness CT2 of the second lens on the optical axis and a center thickness CT3 of the third lens on the optical axis satisfy:
4.1<f123/(CT1+CT2+CT3)<4.9.

15. The optical imaging lens assembly according to claim 1, wherein an edge thickness ET4 of the fourth lens, an edge thickness ET5 of the fifth lens, a center thickness CT4 of the fourth lens on the optical axis and a center thickness CT5 of the fifth lens on the optical axis satisfy:
0.7<(ET4+ET5)/(CT4+CT5)<1.0.

16. The optical imaging lens assembly according to claim 1, wherein TTL is a spacing distance from the object-side surface of the first lens to an imaging surface of the optical imaging lens assembly on the optical axis, and ImgH is a half of a diagonal length of an effective pixel region on the imaging surface of the optical imaging lens assembly, TTL and ImgH satisfy:
4.5 mm<TTL×TTL/ImgH<5.5 mm.

17. The optical imaging lens assembly according to claim 1, wherein the maximum FOV of the optical imaging lens assembly satisfies:
70°<FOV<90°.

18. The optical imaging lens assembly according to claim 1, wherein an effective focal length f1 of the first lens, an effective focal length f4 of the fourth lens and a total effective focal length f of the optical imaging lens assembly satisfy:
1.6<(f1+f4)/f<2.1.

19. The optical imaging lens assembly according to claim 1, wherein an effective focal length f2 of the second lens and an effective focal length f5 of the fifth lens satisfy:
2.2<f2/f5<3.8.

20. An optical imaging lens assembly, sequentially comprising, from an object side to an image side along an optical axis:
a first lens with a positive refractive power;
a second lens with a negative refractive power;
a third lens with a refractive power, an object-side surface thereof is a convex surface;
a fourth lens with a positive refractive power; and
a fifth lens with a negative refractive power, an object-side surface thereof is a convex surface,
wherein an on-axis distance VP from an intersection point of a straight line where a marginal ray of the optical imaging lens assembly and the optical axis to an object-side surface of the first lens and a maximum field of view (FOV) of the optical imaging lens assembly satisfy:
1.0 mm<2×VP×tan(FOV/2)<1.5 mm.
